(19) United States
(12) Patent Application Publication
(10) Pub. No.: US 2008/0066340 A1
(43) Pub. Date: Mar. 20, 2008

(54) Depressurization Type Drying Machine and Method for Drying Lumber Using the Same

(75) Inventor: Toshimitsu Kakuno, Fukuoka (JP)

Correspondence Address: AKERMAN SENTERFITT, 801 PENNSYLVANIA AVENUE N.W., SUITE 600, WASHINGTON, DC, 20004, US

(73) Assignee: Kakuno Seisakusho Co., Ltd., Fukuoka (JP)

(21) Appl. No.: 11/661,536

(22) PCT Filed: Aug. 29, 2005
(86) PCT No.: PCT/JP05/15663

§ 371 Date: Aug. 15, 2007

(30) Foreign Application Priority Data
Aug. 31, 2004 (JP) 2004-253633

(51) Int. Cl. F26B 5/04

(52) U.S. Cl. 34/489; 34/191

(57) ABSTRACT

The present invention provides a depressurization type drying machine that is capable of repeatedly reducing the pressure, heating and humidifying during drying, uniformly drying a material to be dried, in a short time by applying vibrations to the material to be dried when reducing the pressure, and reducing consumption power without damaging the material to be dried, is excellent in reliability, productivity and energy-saving properties, brings about almost no flaws such as warping, internal cracking, breaking, shrinkage, bending, and surface cracking, especially when drying lumber, is also capable of leaving gloss on the surface of lumber after drying and scent without any discoloring, has high commercial value since the humidity in a building may be permanently controlled in response to the environment after being constructed, and is capable of extracting moisture contained in a material to be dried such as lumber without any waste and effectively utilizing the same as by-products. At least the ceiling portion and sidewall portions are formed roughly like a circular arc swelled outwardly, and reinforcement ribs are provided, which are disposed along the outer circumference of the inner wall parallel to and/or in orthogonal to the lengthwise direction of the drying chamber between the respective outer walls and inner walls of the ceiling portion, the sidewall portions and the floor portion.

### TECHNICAL FIELD

The present invention relates to a depressurization type drying machine and a method for drying lumber using the same, which are capable of uniformly drying organisms such as lumber, etc., in a short time by depressurizing, heating, humidifying, dehumidifying the organisms during drying, and simultaneously vibrating materials to be dried when depressurizing.

### BACKGROUND OF THE INVENTION

Conventionally, first, there is a hot air drying system as a method for artificially drying lumber. In a drying chamber of the system, steam is applied to lumber to be dried and hot air is blown thereinto for drying. Application of steam prevents the lumber from being cracked due to the surface thereof becoming hot by blowing of hot air and transmits heat of hot air into the inside of the lumber by steam. Therefore, in the system, the temperature and humidity in the drying chamber greatly change due to the elapse of time, wherein since the temperature and humidity of lumber greatly changes, the lumber is easily subjected to cracking, breaking, deformation and shrinkage, etc., when lumber is dried. Further, a large quantity of heat is required to generate steam and hot air, wherein there is a problem that the fuel cost thereof is increased.

Further, moisture in lumber is evaporated and lumber is dried by blowing high temperature air heated in a heat radiation section secured on the ceiling of a drying chamber or at the side thereof into the drying chamber by means of a blower, and at the same time, is flown and circulated to the heat radiation section again. However, since hot air will be subjected to circular flows from the bottom position to the heat radiation section after the hot air blown into the ceiling lowers along the inner-circumferential wall, wherein since the hot air does not uniformly circulate to the interior position of the lumber and position at both the ends thereof, there is another problem that the lumber is subjected to bending and/or cracking due to unevenness in the drying degree. Still further, in drying for which the temperature of hot air is maintained at 50° C. or so while the humidity is maintained at 70% through 80%, it takes approximately two weeks until the lumber is completely dried. Therefore, the fuel cost becomes expensive, and if the temperature of hot air is increased to shorten the drying time, there is still another problem that cracking will be increased.

Second, there is a dehumidifying system using a sheathed heater. In this system, air is circulated to dry lumber in a drying chamber, circulating air is cooled and dehumidified, the cooled and dehumidified air is warmed, the warmed air is further heated by a sheathed heater, and at the same time, the air is exposed to ultraviolet rays and is sent into the drying chamber. Moisture coming from the lumber is removed by cooling and dehumidifying the circulating air, and the heated air is exposed to ultraviolet rays and is blown into the lumber, whereby the lumber is dried. However, since an ultraviolet ray whose wavelength is short is applied to lumber, there is still another problem that the surface of the lumber is made black, and consumption power therefor is increased.

In order to solve these problems, (Patent Document 1) discloses [a control apparatus for lumber drying apparatus, comprising: a fan for circulating air in a drying chamber in which lumber is accommodated; a heater for heating the air in the drying chamber to a predetermined value of temperature; a dehumidifier for lowering the humidity in the drying chamber; a pressure reducer for reducing the atmospheric pressure in the drying chamber; and a humidity sensor for detecting the humidity in the drying chamber; wherein the dehumidifier is actuated when the detection value of the humidity sensor becomes a predetermined value or more, and simultaneously the pressure reducer is stopped, and the dehumidifier is stopped when the detection value of the humidity sensor becomes a predetermined value or less, and simultaneously the pressure reducer is actuated].

Also, the (Patent Document 2) discloses [a lumber drying apparatus having lumber accommodated in a drying chamber that is sealed completely and heat-insulated state, and circulating air in the drying chamber, comprising: a cooling and dehumidifying device for cooling circulating air and dehumidifying the same; a heating device for heating the cooled and dehumidified air; a far-infrared ray heater for passing warmed air therethrough, heating the air, and simultaneously mixing far-infrared rays with the air; and a send-off device for sending off air mixed with far-infrared rays into the drying chamber].

(Patent Document 3) discloses [a drying apparatus in which a circulation fan for forcedly sending air downward is disposed on the ceiling of a drying chamber; a heater for heating the forcedly sent air is disposed at both ends of the lower side of the drying chamber, and a far-infrared ray heater for supplying far-infrared rays toward materials to be dried is disposed on the wall surface of the lower part of the drying chamber in which the material to be dried is placed, an ambient air inflow port for introducing the atmospheric air into the drying chamber, and an air exhaust port for exhausting air in the drying chamber to the outside thereof are provided on the wall side of the upper part of the drying chamber].

(Patent Document 4) discloses [a drying apparatus including air send-off portions for sending off hot air invertically multiple layers on one inner wall surface along the lengthwise direction of an airtight chamber thereof, and air intake portions for taking in hot air in vertically multiple layers on the other inner circumferential wall surface thereof, are provided, and uniformly ventilating hot air in the horizontal direction in an airtight chamber by forcedly taking in and circulating hot air from the send-off portions to the intake portions based on a push-pull system].

(Patent Document 5) discloses [a method for treating lumber, comprising the steps of accommodating the lumber in a casing, directly applying vibrations to the lumber while heating, and moving moisture and constituents in the lumber from the interior thereof to the exterior thereof when drying the lumber].

(Patent Document 6) discloses [a drying machine for drying organisms such as lumber, comprising: a drying chamber; a dehumidifier disposed at the rear wall side of the drying chamber; an outdoor compressor interconnected with the dehumidifier; an outdoor vacuum pump interconnected with the drying chamber; a rectification core having a plurality of air pores drilled therein and forming an air path; a circulation fan disposed on the inner wall of the drying chamber; a carriage on which materials to be dried are placed; a carriage guiding portion disposed on the floor of the drying chamber; a moisture extraction tube interconnected with the dehumidifier for extracting moisture taken from the material to be dried; and various sensors for measuring the temperature, humidity, pressure in the drying chamber, and the weight of the materials to be dried loaded on the carriage and the quantity of extracted moisture.

Patent Document 1: Japanese Published Examined Patent Application No. H08-12035

Patent Document 2: Japanese Published Unexamined Patent Application No. H10-325677

Patent Document 3: Japanese Published Examined Utility Model Application No. H04-33757

Patent Document 4: Japanese Published Examined Utility Model Application No. H04-82690

Patent Document 5: Japanese Patent No. 3590782

Patent Document 6: Japanese Published Unexamined Patent Application No. 2004-306579

### SUMMARY OF THE INVENTION

### Objects to be Solved by the Invention

However, there are the following problems in the prior arts described above.

(1) In (Patent Document 1), since the reduction pressure is remarkably slight although drying is carried out by repeating dehumidification and depressurization, only the surface of lumber is first dried, drying irregularities are apt to occur at the surface of lumber and in the core portion thereof, and it takes a long time until the core portion is dried. Therefore, the apparatus according to Patent Document 1 has problems in that the apparatus is short in practicability, energy-saving properties and productivity, and the surface of lumber is apt to be cracked, wherein reliability is not sufficient. Also, since the drying chamber thereof is not provided with any air path, it is difficult to uniformly dry lumber, wherein there is another problem that since the lumber is apt to be warped, cracked, or is subjected to bending and contraction, reliability is not sufficient. Further, there is still another problem that since the atmospheric air is taken in the drying chamber during drying, it is difficult to uniformly control the temperature and humidity, and the apparatus is short in practicability and operation efficiency.

(2) In (Patent Document 2), since heating is carried out by a far-infrared ray heater, the facility cost and running cost are expensive, cost performance is not satisfactory, and at the same time, since an air path is formed only on the upper surface of the drying apparatus, it is not possible to send air from the upper surface or from the sides in the lengthwise direction to lumber, wherein since air is supplied only from one end (the front side) in the lengthwise direction, uniformly drying cannot be carried out and cracking is apt to occur at the end face portions, wherein there is a problem that the apparatus is short in reliability. Further, since the atmospheric air is taken in during drying, it is difficult to uniformly control the temperature and humidity, wherein there is another problem that the apparatus is short in practicability and operation efficiency.

(3) In (Patent Document 3), since the apparatus is provided with a fan for forcedly sending off air downward at the ceiling of the drying chamber thereof and has an air path formed of partition walls, air in the drying chamber may be circulated. However, since heating is carried out by far-infrared ray heaters disposed on both side walls of the drying chamber, the side portions of lumber are first dried, and the drying becomes uneven, wherein there is a problem that lumber is easily subjected to warping, breaking, shrinkage, bending, etc., and the apparatus is short in reliability. Also, since the drying chamber has such a structure by which depressurization is not available although it is completely sealed, wherein it takes a long time for drying, there is another problem that the apparatus is short in productivity, and energy-saving properties.

(4) In (Patent Document 4), air send-off portions for sending off hot air in vertically multiple layers on one inner wall surface along the lengthwise direction of an airtight chamber thereof, and air intake portions for taking in hot air in vertically multiple layers on the other inner circumferential wall surface thereof, are provided, and hot air is ventilated in the horizontal direction in the airtight chamber by forcedly taking in and circulating hot air from the send-off portions to the intake portions based on a push-pull system. Therefore, air may be supplied to lumber only from one direction, wherein the lumber is rapidly dried at the air send-off side, and warping, breaking, shrinkage, and bending are apt to occur. Accordingly, there is a problem that the apparatus is short in reliability. In addition, since the airtight chamber has such a structure the pressure of which cannot be reduced although it is completely sealed, it takes along time to dry lumber, wherein there is another problem that the apparatus is short in productivity and energy-saving properties.

(5) In (Patent Document 5), although according to the method moisture and constituents in lumber are moved from the inside of the lumber to the exterior thereof while directly applying vibrations to the lumber while heating, no detailed heating temperature and vibration amplitude are disclosed. Also, the conditions of pressurization, humidification, and depressurization in the casing are not disclosed.

Therefore, when taking the detail of application into consideration, the document of the examination request describes [the interior of the casing is heated for five hours at a temperature of 110° C. through 120° C. in a steam-saturated state, and thereafter a material A is given vibrations 12000 through 15000 times per minute for three hours at the same time when depressurizing (70 cmhg).

Taking these into consideration together the above description and a description stating [deposits that stop moisture channels in the interior of lumber such as vessels may be isolated by directly giving vibrations] in the specification, it is considered that cells are destroyed by high temperature heating at a temperature of 110° C. through 120° C. and vibrations, whereby moving paths are increased and fluidity of moisture is increased.

If lumber is heated to 60° C. or higher and cells are destroyed, essential oil is discharged together with moisture, wherein there is a problem that the interior of the drying apparatus is stained. Further, although cracking is prevented from occurring by covering the surface of lumber with lignin, internal cracking is apt to occur if lumber is shrunk with the essential oil removed, and the lumber is apt to be broken, wherein there is another problem that according to the method, there is a shortage in durability, imperishability, and practicability.

(6) (Patent Document 6) has been filed by the applicant of this application. With the apparatus, organisms such as lumber are not damaged by lowering the drying temperature, almost no defects such as warping, breaking, shrinkage, bending, etc., are brought about especially when drying lumber, gloss remains on the surface of lumber after it is dried, and scent also remains. Therefore, the apparatus has a high commercial value, and is an apparatus for drying organisms such as lumber, by which moisture contained in the lumber is extracted without any waste and may be effectively utilized as by-products. In comparison with the prior art steam type drying apparatus, it is possible to remarkably reduce the size of cracking and ratio of occurrence thereof, to improve the yield, to lower unevenness in moisture content by giving vibrations when dehumidifying and drying with cold air, and to improve the commercial value of lumber after it is dried. However, it is demanded that drying time is further reduced, and productivity is improved by reducing end cracking and surface cracking.

The present invention was developed to solve the problems and shortcomings described above, and it is therefore an object of the invention to provide a depressurization type drying machine that is capable of repeatedly reducing the pressure, heating and humidifying during drying, uniformly drying a material to be dried, in a short time by applying vibrations to the material to be dried when reducing the pressure, and reducing consumption power without damaging the material to be dried, is excellent in reliability, productivity and energy-saving properties, generates almost no flaws such as warping, internal cracking, breaking, shrinkage, and surface cracking, especially when drying lumber, is also capable of leaving gloss on the surface of lumber, scent without any discoloring and essential oil after being dried, is also excellent in durability and imperishability, has high commercial value since the humidity in a building may be permanently controlled in response to the environment after being constructed, and is capable of extracting moisture contained in a material such as lumber without any waste and effectively utilizing the same as by-products, and to provide a method for drying lumber using a depressurization type drying machine that is excellent in energy-saving properties and productivity since being capable of drying lumber at high quality in a short time.

### Means for Solving the Object

In order to solve the above-described problems, a depressurization type drying machine according to the invention and a method for drying lumber using the same have the following configuration.

A depressurization type drying machine according to a first aspect of the invention includes a drying chamber in which a ceiling portion, sidewall portions, and a floor portion are formed to be a dual-structure composed of an outer wall and an inner wall, a heat insulation layer formed between the outer wall and the inner wall, and a sealing type door disposed at the front sidewall portion of the drying chamber, depressurizes the interior of the drying chamber, and dehumidifies and dries a material to be dried in the drying chamber at a low temperature, wherein at least the ceiling portion and sidewall portions are formed roughly like a circular arc swelled outwardly, and includes: reinforcement ribs disposed along the outer circumference of the inner wall parallel to and/or in orthogonal to the lengthwise direction of the drying chamber between the respective outer walls and inner walls of the ceiling portion, the sidewall portions and the floor portion; a dehumidifier disposed at the rear wall side of the drying chamber; an outdoor compressor interconnected with the dehumidifier; an outdoor vacuum pump interconnected with the drying chamber for depressurizing the interior thereof; a rectification plate disposed apart from the inner wall on the ceiling portion for forming a ceiling air path; a plurality of air pores drilled in the rectification plate; and a heater disposed on the ceiling portion of the drying chamber; wherein the rectification plate is spaced from the inner wall at both sides in the widthwise direction and is opened, the ceiling air path communicates with an air feeding duct of the dehumidifier at the rear wall of the drying chamber, and the air circulating unit disposed on the ceiling portion of the drying chamber includes a blower disposed at the rear wall side of the drying chamber; an air pipe connected to the blower and disposed in parallel to the lengthwise direction of the drying chamber at both sides of the ceiling portion; and a plurality of air jetting pores drilled in the air pipe.

With the construction, the following actions are brought about.

(1) Since the ceiling portion, sidewall portions, and floor portion of the drying chamber are formed to be a dual-structure composed of the outer wall and inner wall, and the system is provided with a sealing type door disposed at the front sidewall portion of the drying chamber and a heat insulation layer formed between the outer wall and the inner wall, the system may increase the efficiency when cooling and heating the interior of the drying chamber by controlling heat radiation from the drying chamber and heat absorption from the exterior of the drying chamber, and at the same time, the temperature in the drying chamber is stabilized and is maintained at a fixed level.

(2) Since the ceiling portion and sidewall portions are formed roughly like a circular arc swelled outwardly, the ceiling portion and sidewall portions are only resiliently deformed even by depressurizing the interior of the drying chamber, wherein no plastic deformation occurs. Therefore, even if depressurization is repeated, the drying chamber is not broken, and is excellent in durability.

(3) Since reinforcement ribs are provided, which are disposed along the outer circumference of the inner wall parallel to and/or in orthogonal to the lengthwise direction of the drying chamber between the respective outer walls and inner walls of the ceiling portion, the sidewall portions, and the floor portion, the outer walls and inner walls are firmly supported by means of the reinforcement ribs, wherein the ceiling portion and the sidewall portions may be prevented from being deformed, and the interior of the drying chamber may be depressurized at a high pressure. Therefore, it is possible to uniformly dry the material in a short time.

(4) Since the dehumidifier is disposed at the rear wall side of the drying chamber, the rectification plate is disposed on the ceiling portion apart from the inner wall, and the ceiling air path is formed, air in the drying chamber can be stirred by the air circulating unit disposed at the ceiling portion while circulating the same, and at the same time, the entirety of the materials to be dried may be covered up with dry air jetted from a plurality of air pores drilled in the rectification plate, wherein the interior of the drying chamber may be kept on uniform drying conditions, and in particular when drying lumber, it is possible to prevent the lumber from being subjected to warping, internal cracking, breaking, shrinkage, bending, etc.

(5) Since the interior of the drying chamber is depressurized to lower the boiling point by providing an outdoor vacuum pump, humidity in the core portion of the materials to be dried is diffused to the surface to enable drying with the internal temperature kept at a low temperature. Therefore, the drying time may be shortened, and the materials to be dried may be uniformly dried. In particular, when drying lumber, it is possible to prevent the lumber from being subjected to warping, internal cracking, breaking, shrinkage, bending, etc.

(6) Since the interior of the drying chamber is heated over the boiling point by a heater with the boiling point lowered in the drying chamber by depressurizing the interior of the drying chamber by the outdoor vacuum pump, it is possible to shorten the drying time.

(7) The drying time may be shortened by easily heating the interior of the drying chamber by the heater, and even in a cold district or when the ambient temperature is low in winter time, it is possible to keep the interior of the drying chamber at a roughly fixed temperature set in advance, wherein it is possible to reduce unevenness in the drying time and the drying conditions.

(8) Since the air circulating unit is provided with air pipes connected to the blower and disposed in parallel to the lengthwise direction of the drying chamber at both sides of the ceiling portion, air may be jetted from a plurality of air jetting pores drilled in the air pipes, and air in the drying chamber may be stirred, wherein the atmosphere in the drying chamber may be made uniform, and drying irregularities are prevented from occurring.

(9) Since the air pipes are disposed in parallel to the lengthwise direction of the drying chamber at both sides of the ceiling portion, air in the entire drying chamber may be stirred without any irregularity, wherein it is possible to uniformly dry the materials to be dried regardless of any place therein, and in particular, when drying lumber, it is possible to effectively prevent lumber from being subjected to end cracking, warping and bending, etc.

Here, the size of the drying chamber may be varied based on the installation place, treatment capacity, and type of a material to be dried. For example, if the material is lumber of specified length, it is preferable that the internal volume of the drying chamber is approximately 15 m³ through 80 m³. In this case, it is possible to mount the depressurization type drying machine on a vehicle, and the drying machine may be conveyed to any site of accumulating of materials to be dried such as lumber, and the materials may be dried at the site.

A heat insulation layer is formed by disposing a heat insulating material between the outer wall and the inner wall. A material having high flexibility, which is easy to be processed, and is used for heat insulation of industrial facilities, such as glass wool, foamed polyurethane, rock wool molded to be plate-like may be favorably utilized as the heat insulating material.

The spacing between the outer wall and the inner wall may be appropriately selected in compliance with the size of the drying chamber. However, where the internal volume is as described above, and the material to be dried is lumber, it is preferable that the spacing is 150 mm through 200 mm.

Rolled steel materials and stainless steel materials for general structure may be favorably used for the material of the outer wall, inner wall and reinforcement ribs that form the drying chamber.

The plate thickness of the outer wall, inner wall and reinforcement ribs may be appropriately selected in compliance with the size of the drying chamber. However, where the internal volume is as described above, and the material to be dried is lumber, it is preferable that the thickness is 6 mm through 9 mm.

As the plate thickness is made thinner than 6 mm, the strength may be weakened, wherein the drying chamber is apt to be deformed when reducing the pressure thereof, and the durability and reliability thereof are lowered. If the plate becomes thicker than 9 mm, the weight of the drying chamber is increased, wherein it is difficult to handle or carry it, and the workability and productivity are lowered. Both of these are unfavorable.

The pitch of disposing the reinforcement ribs may be appropriately selected in compliance with the size of the drying chamber. However, where the internal volume is as described above, and the material to be dried is lumber, it is preferable that the pitch is 450 mm through 600 mm in both the lengthwise direction of the drying chamber and the circumferential direction thereof. As the pitch is less than 450 mm, the number of steps of machining is increased to lower the workability, and the entire weight of the drying chamber is increased to increase the production cost. As the pitch is wider than 600 mm, the strength becomes short, and the drying chamber is deformed when reducing the pressure thereof, wherein the durability and reliability are lowered. Both of these are unfavorable.

By forming the plate thickness of the outer wall, inner wall and reinforcement ribs, and forming the ribs in the above-described range of pitch, it is possible to depressurize the drying chamber to −100 kPa or so. In addition, notched parts may be formed on the inner wall side of the reinforcement ribs at a pitch of 100 mm through 200 mm, whereby the contact area between the inner wall and the reinforcement ribs may be reduced to reduce the thermal transmission from the interior of the drying chamber to the reinforcement ribs, and the heat insulation efficiency may be improved.

Where a plurality of lifting rings are provided on the external wall of the ceiling portion and the side walls of the drying chamber, it is possible to easily lift and convey the depressurization type drying machine, and to load the same on a trailer, etc., and to convey anywhere.

The rectification plate is made of metal such as stainless steel, and air pores drilled in the surface are formed by laser machining. Wherein lattice-shaped reinforcement members are disposed on the rectification plate, deformation thereof may be prevented from occurring, and excellent durability is brought about.

The rectification plate is suspended from and fixed on the inner wall of the ceiling portion by fixing means such as bolts and nuts.

Also, where the tip end and the rear end of the rectification plate are made circular arc-shaped, it is possible to rectify the air flows in the drying chamber, and the strength thereof may be increased to improve the pressure resistance.

By disposing side plates for rectification with a predetermined interval to the inner wall at the left and right sidewall portions in addition to the rectification plate of the ceiling portion, side wall air paths may be formed. Also, by drilling a plurality of air pores in the side plates for rectification as in the rectification plate, dry air is supplied from sideways, and the atmosphere in the drying chamber may be made uniform.

Wherein side plates for rectification are provided, they may be formed of members separate from the rectification plate, or may be formed to be roughly channel-shaped integral therewith. In addition, where the dimension of the drying chamber is long in the lengthwise direction, partitioning plates are provided between the side plates for rectification and the inner walls, whereby the interior in the sidewall air paths may be divided into a plurality in the lengthwise direction. By feeding air in respective sidewall air paths partitioned into a plurality, it is possible to prevent the air capacity from being lowered, and it is possible to securely jet air through a plurality of air pores.

The shape of air pores may be formed to be circular or slot-shaped. The size and pitch of the air pores may be appropriately selected in compliance with the size of the drying chamber.

Where the internal capacity of the drying chamber is as described above, and the material to be dried is lumber, it is preferable that the diameter of an air pore is 40 mm through 70 mm, and the length of a slot is 50 mm through 80 mm. If the diameter of the air pore is less than 40 mm or the length of the slot is less than 50 mm, a sufficient air capacity cannot be obtained, where there is a tendency for the drying to be made slow, and if the diameter of the air pore is more than 70 mm or the length of the slot is more than 80 mm, a sufficient air capacity cannot be obtained, wherein there is a tendency for circulation and stirring of air to become difficult. Either of them is not favorable.

Where the internal capacity of the drying chamber is as described above, and the material to be dried is lumber, it is preferable that the pitch of air pores is 200 mm through 350 mm. If the pitch thereof is less than 200 mm, the air pores are made too dense, wherein a sufficient air capacity cannot be obtained, and there is a tendency for circulation of air to become difficult in the drying chamber, and if the pitch is more than 350 mm, a sufficient air capacity cannot be obtained, wherein there is a tendency for the drying to become slow. Either of them is not favorable.

By keeping the dimensions of the air pores and the pitch thereof in the above-described specification, it is possible to appropriately control the velocity and flows of air jetted through the air pores in the drying chamber, wherein drying may be uniformly and efficiently carried out.

The heater is disposed on the inner wall of the ceiling portion and the sidewall portions. By disposing a plurality of heaters in the widthwise direction and the lengthwise direction of the drying chamber, the entirety of the drying chamber may be uniformly heated in a short time. In particular, where the heater is disposed on the ceiling portion, air in the ceiling air path may be circulated by the air circulating unit while being uniformly heated, wherein the drying chamber may be heated in a short time, and the efficiency is excellent.

The air circulating unit may be disposed on the inner wall of the ceiling portion of the drying chamber. Where a blower or a stirring unit is used as the air circulating unit, it may be slidably disposed on the inner wall, and may be caused to move between the front side and the rear side of the drying chamber. Accordingly, the interior of the drying chamber may be made into uniform drying conditions by adjusting the air direction and air capacity. Also, an air circulating unit such as a blower, an air stirring unit, etc., may be disposed at the sidewall portions of the drying chamber and on the bottom portion, whereby air in the drying chamber is stirred, and a further uniformly dried state may be obtained.

In addition, a floor plate for rectification, which is similar to that for the top plate portion and the sidewall portions, may be disposed on the floor portion. Where a blower for floor is disposed between the floor plate for rectification and the inner wall, and dry air is blown through air pores drilled in the floor plate for rectification, it is possible to jet dry air from bottom of the materials to be dried and to uniformly dry the entirety of the materials to be dried from all the directions, and in particular when drying lumber, it is possible to effectively prevent the lumber from being subjected to warping, internal cracking, breaking, shrinkage, and bending, etc. Further, since dry air may be blown from the front sidewall side in the floor air path to the rear wall side thereof, air may be circulated in the drying chamber, wherein the drying efficiency is excellent.

Where a water intake tank interconnected to a dehumidifier is disposed outside the drying chamber, it is possible to extract moisture taken out of the materials to be dried, wherein moisture thus extracted may be effectively utilized as by-products.

A drain cock is attached to the water intake tank or a drain pump is disposed in the tank, and a great deal of extracted moisture is stored in a separate container, etc., wherein it is possible to easily and securely extract a large quantity of moisture.

If the weight of materials to be dried is measured before drying, it is possible to know the drying state of the materials based on the quantity of moisture extracted during drying. In particular, when drying lumber, it is possible to acquire the moisture content without directly measuring the moisture content by means of a moisture content meter, wherein workability is excellent.

An inlet pipe interconnected to the rear wall side of the drying chamber is connected to the blower. Thereby, air may be circulated between the drying chamber and the blower.

The diameter of air pipe, diameter of air jetting pores and pitch thereof may be appropriately selected so that required quantity of air may be obtained based on the capacity of the drying chamber.

Where the internal volume of the drying chamber is as described above, and the material to be dried is lumber, it is preferable that the diameter of air pipe is 100 mm through 150 mm, the diameter of air jetting pore is 30 mm through 50 mm, and the pitch of air jetting pores is 200 mm through 400 mm. Where the internal volume of the drying chamber is small, and the dimension in the lengthwise direction is short, there is no problem in that these members may be equally disposed in the lengthwise direction. However, where the dimension in the lengthwise direction is long, it is preferable that the diameters of air pipes and the diameters of air jetting pores, and the pitches thereof are stepwise varied at the upstream side and the downstream side, so that roughly equivalent air capacity may be obtained at any place in the drying chamber.

It is preferable that the air jetting pores are obliquely drilled outward of the drying chamber so that jetted air may flow along the inner wall of the drying chamber.

In addition, where blowers respectively connected to the air pipes disposed at both sides of the ceiling portion are driven alternately, air is jetted only from the air jetting pores at either of the left and right sides of the drying chamber, wherein it is possible to stir air in the drying chamber clockwise or counterclockwise. Since, by jetting air from the left and right air pipes alternately, it is possible to prevent the drying state from differing at the left and right sides in the drying chamber, the reliability is excellent.

Further, where air is jetted selectively from either of the left and right air pipes by means of a change valve, it is possible to reduce the number of blowers. Still further, where air is jetted from the left and right air pipes at the same time, air flows jetted from the left and right sides are brought into collision with each other at the middle part and are elevated to make convection, thereby stirring the entirety of air in the drying chamber.

A depressurization type drying machine according to a second aspect is a drying machine according to the first aspect, which includes: a temperature sensor for measuring the temperature in the drying chamber; a humidity sensor for measuring the humidity in the drying chamber; and a pressure sensor for measuring the depressurization degree in the drying chamber. With the construction, the following actions are brought about in addition to the actions according to the first aspect.

(1) Since the drying machine is provided with a temperature sensor for measuring the temperature in the drying chamber, a humidity sensor for measuring the humidity in the drying chamber, and a pressure sensor for measuring the pressure degree in the drying chamber, the status in the drying chamber may be monitored to set the optimal drying conditions.

The temperature sensor, humidity sensor and pressure sensor are disposed on the inner wall or the like of the ceiling portion and the sidewall portions and the like. Where a plurality of temperature sensors and humidity sensors are disposed, the average temperature and humidity in the drying chamber may be measured, wherein the sensors are less influenced by dehumidification by a dehumidifier and cooling or heating, and reliability is excellent.

A water-sealed type pump which is best suitable for exhaust of gas including steam and water drops may be preferably used as the outdoor vacuum pump. In addition, it is favorable that the temperature of sealing water used for circulation is kept at 40° C. or less by means of a cooling unit, wherein it is possible to prevent the exhaust speed from being lowered due to rise in the water temperature, and reliability and operation stability are excellent.

A depressurization type drying machine according to a third aspect is a drying machine according to the first aspect or the second aspect, which includes a spraying unit disposed at the front sidewall portion side of the drying chamber.

With the construction, the following actions are brought about in addition to the actions according to the first aspect or the second aspect.

(1) Since the spraying unit is provided, it is possible to restore the humidity in the drying chamber, which is lowered by depressurization, and humidity is supplied to the surface of a material to be dried, wherein the material is prevented from being dried only on the surface, and balance is taken in drying between the interior of the material and the surface thereof, thereby enabling uniformly drying of the entirety of the material to be dried. In particular, when drying lumber, it is possible to effectively prevent surface cracking from occurring.

(2) Since the spraying unit is provided at the front sidewall portion side, moisture from mist sprayed from the spraying unit is diffused in the entirety of the drying chamber in line with circulation and stirring of air by means of the air circulating unit, wherein it is possible to uniformly keep the humidity in the drying chamber.

The spraying unit may be of any type as far as it may spray water in a mist form. For example, such a type may be favorably used, which sprays water stored in a water reservoir by pressure of a compressor like mist. The number of the spraying units may be appropriately selected in compliance with the section area of the drying chamber. Where the spraying units are installed at the front sidewall portion side of the drying chamber, air containing moisture from mist sprayed is stirred and circulated by actions of the air circulating unit, wherein the humidity of the drying chamber may be uniformly maintained. In particular, since moisture from mist may be sprayed to the entirety from the ceiling portion to the floor portion, it is possible to efficiently spread air containing moisture to all the corners of the drying chamber.

It is favorable that the humidity in the drying chamber, which is adjusted by the spraying unit, is 60% through 95%, preferably 80% through 95%. If the humidity becomes lower than 80%, the surface evaporation becomes faster than the internal diffusion, wherein surface drying is apt to occur, and an effect based on humidification becomes insufficient. In particular, in the case of lumber, there is a tendency of a lowering in the commercial value because the lumber is apt to be subjected to discoloring and surface cracking. To the contrary, if the humidity becomes higher than 95%, the drying time is lengthened. In particular, the effect based on humidification becomes insufficient as the humidity becomes lower than 60%, wherein it is not favorable that surface drying becomes remarkable.

A depressurization type drying machine according to a fourth aspect is a drying machine according to any one of the first aspect through the third aspect, which includes a carriage disposed so as to be carried in and out of the interior of the drying chamber, on which the materials to be dried are loaded, and a vibration generating unit disposed on the carriage for giving vibrations to the materials to be dried.

With the construction, the following actions are brought about in addition to the actions according to any one of the first aspect through the third aspect.

(1) Since the carriage on which the materials to be dried are loaded may be carried in and out of the interior of the drying chamber, it is possible to load and unload the materials outside the drying chamber, wherein the materials may be easily conveyed.

(2) Since vibrations may be given to the materials to be dried, by the vibration generating unit disposed on the carriage, air absorbing moisture and the atmospheric air are positively stirred and exchanged in the vicinity of the surface of the materials to be dried. Therefore, the drying time may be shortened.

(3) After the interior of the drying chamber is heated by the heater, the drying chamber is depressurized by the outdoor vacuum pump, wherein by giving vibrations to the materials in a state where the boiling point is lowered less than the temperature in the drying chamber, moisture in the core portion may be diffused to the surface, and uniformly drying may be carried out in a short time by an synergistic effect of heating and depressurized vibrations.

Here, it is favorable that the loading surface of the carriage is formed of a lattice-shaped framework, wherein air flown in from the sides and bottom side of the carriage may be applied to the bottom of the materials to be dried, which are loaded on the carriage, thereby enabling further uniformly drying.

The carriage may be manually let in and out or may be automatically moved by providing electromotive sliding means in the drying chamber. Where a carriage guiding portion consisting of rail portions for guiding the wheels of the carriage and stopper portions for stopping and/or fixing the carriage at a predetermined position is provided in the drying chamber, the carriage may be easily guided to and installed at a predetermined position. It is possible to prevent the carriage from be erroneously brought into collision with the inner wall surface and facilities of the drying chamber, wherein the reliability and workability are excellent.

Where amass sensor is provided in the carriage, it is possible to easily detect the mass (or weight) of materials to be dried, when loading the material to be dried on the carriage. The work efficiency may be improved by knowing the loading amount. Further, it is possible to know the moisture content by measuring the mass (weight) of the materials to be dried during drying.

There are some types of vibration generating unit, for example, inertia type, electromotive type, and hydraulic type. However, the inertia type that is small-sized, maintenance of which is easy, may be preferably used. The inertia type vibration generating unit is an electro-turning type and gives vibrations so as to depict a circular motion. The amplitude of the vibration generating unit may be selected in response to the type of a material to be dried. However, where the material is lumber, it is preferable that the amplitude is 0.5 mm through 11.0 mm. If the amplitude is smaller than 0.5 mm, the movement amount of air having high humidity on the surface of the material to be dried is apt to decrease, wherein disposition thereof with dry air becomes short to cause the drying time to be lengthened. To the contrary, if the amplitude is larger than 11.0 mm, the entirety of the materials to be dried greatly vibrates, wherein diffusion of the moisture becomes insufficient. Either of them is not favorable.

Based on a synergistic effect of lowering the boiling point in the drying chamber to 40° C. through 60° C. that is equivalent to the temperature in the drying chamber by depressurization after the interior of the drying chamber is heated to 40° C. through 60° C. and of giving vibrations to the materials to be dried, moisture in the core portion may be diffused to the outer surface, and the drying time may be shortened. Therefore, uniformly drying may be achieved without giving any damage to the material to be dried. In particular, where the material is lumber, gloss may remain on the surface of lumber after it is dried, and scent also remains with no discoloring brought about. And it is possible to prevent lumber from being subjected to warping, internal cracking, breaking, shrinkage, bending, etc.

The vibration generating unit may be disposed at the sides of the carriage and at both sides of the bottom side thereof. Also, it is preferable that a resilient body such as rubber and a spring, having suitable rigidity is disposed at the wheel attaching portion of the carriage, wherein vibrations are prevented from being transmitted to the wheel side of the carriage, and it is possible to securely vibrate the materials to be dried, on the carriage.

By the entirety of the materials to be dried on the carriage being tightened at several points by band-shaped fixing members having flexibility such as rubber, the materials to be dried may be prevented from collapsing due to vibrations. Also, since the fixing members have flexibility, the materials to be dried may be firmly fixed even where the material shrinks after drying, wherein the reliability is excellent.

Where the material to be dried is lumber, it is preferable that fixtures are used, which line up and support lumber on the carriage in the vertical direction and the horizontal direction with constant spacing secured respectively. Accordingly, the lumber may be efficiently loaded, wherein a plurality of lumber may be dried out under uniform conditions at one time, and the lumber may be securely supported and is prevented from slipping down and collapsing while vibrating the same. Since the lumber at the extremely lower layer is lined up on and supported by the fixtures and is loaded on the carriage, it is possible to form clearance between the loading surface of the carriage and the bottom of loaded lumber, wherein air may be ventilated from the sides and bottom as in the lumber loaded on upper layers, and an uniformly drying state may be secured. In addition, since lumber is loaded in the vertical direction, warping and bending in the vertical direction may be corrected during drying, wherein the quality of lumber may be improved. Further, where the fixtures and the fixing members are concurrently used, it is possible to further securely fix lumber, wherein the reliability and safety may be improved.

Wooden members and foamed synthetic resin members are preferably used as the material of the fixtures, whereby it is easy to process the material, and the material has a sufficient strength where the temperature is not more than 60° C. Therefore, lumber may be supported in safety.

Fixtures are preferably used, which include a flat plate portion formed to be long plate-shaped, and a plurality of supporting parts protruded at predetermined spacing in the lengthwise direction of the flat plate portion, or detachably provided with respect to the flat plate portion and/or slidably fixed parallel to and in the lengthwise direction of the flat plate portion, and which support parts of the bottom and sides of lumber to be loaded. Also, it is favorable that the supporting parts detachably and/or slidably disposed are fixed with screws at the sides in the lengthwise direction of the flat plate portion. Since the supporting parts are fixed at the sides of the flat plate portion, the supporting parts does not hinder lumber to be loaded, and it is possible to easily detach and slide the supporting parts.

By loading lumber and fixtures on the carriage alternately, it is possible to easily line up lumber like grids at an equal interval in the horizontal direction and the vertical direction, wherein the lumber may be securely supported and may be prevented from collapsing when conveying. By supporting parts of the bottom and sides of lumber, clearance is formed between lumber and lumber in the up and down direction and in the left and right direction to cause air to be blown therethrough. Therefore, it is possible to dry a plurality of lumber under uniform conditions at one time, and the productivity is excellent. In addition, the supporting parts disposed at the fixtures are fixed detachably with respect to the flat plate portion and/or slidably parallel to and in the lengthwise direction of the flat plate portion, it is possible to line up lumber at an equal interval so as to easily comply with the number of lumber loaded and the dimensions thereof, and the versatility thereof is excellent.

The depressurization type drying machine is provided with a control portion for controlling the dehumidifier, outdoor unit, outdoor vacuum pump, air circulating unit, spraying unit, heater, and vibration generating unit based on respective values of the temperature sensor, humidity sensor and pressure sensor and the preset programs. Therefore, the operation may be automated not to require any exclusive operator, wherein the number of steps may be reduced. Further, since automated operation is enabled by the control portion, the operation cycle may be shortened by 24-hour operation, etc. to decrease the running costs.

The control portion includes a main power switch of the drying chamber, power switches of respective portions, and an automation operation switch, etc., and it is possible to set the temperature, humidity and depressurization level, which become the drying conditions. Automated operation of the dehumidifier, outdoor unit, outdoor vacuum pump, air circulating unit, spraying unit, heater and vibration generating unit is carried out by the automation operation switch, based on the values of the set temperature, set humidity and set depressurization level. Still further, by providing a timer function, it is possible to automatically start and stop the operation. Also, where it is devised that the number of repetition of depressurization by the outdoor vacuum pump, vibrations by the vibration generating unit and heating/humidifying by the heater and the spraying unit may be set, these actions may be intermittently carried out to further efficiently carry out drying.

A method for drying lumber using a depressurization type drying machine as set forth in a fifth aspect of the invention, includes the steps of: heating the interior of the drying chamber of a depressurization type drying machine according to any one of the first aspect through the fourth aspect to a temperature set in a range from 40° C. through 60° C. by the heater; depressurizing the interior of the drying chamber to −80 kPa through −97 kPa by the outdoor vacuum pump; and dehumidifying the interior of the drying chamber at a temperature set in a range from 20° C. through 40° C. by the dehumidifier.

With the configuration, the following actions are brought about.

(1) Since the heating step, the depressurizing step and the dehumidifying step are provided, the drying conditions are varied according to the drying state of lumber, and the lumber may be efficiently dried.

(2). Since the heating step is carried out at a comparatively low temperature of 40° C. through 60° C., essential oil contents may remain, wherein dried lumber is hardly damaged, and the lumber is prevented from being subjected to warping, internal cracking, breaking, shrinkage, bending and discoloring. Therefore, the durability and anti-corrosion properties thereof are excellent. Gloss remains on the surface thereof, and scent still remains after dried. Therefore, the commercial value of the lumber may be increased.

(3) Since a depressurizing step for depressurizing the interior of the drying chamber to −80 kPa through −97 kPa is carried out after the heating step is completed, the boiling point may be lowered not exceeding the temperature of the interior of the drying chamber, wherein it is possible to dry in a short time even at a low temperature.

(4) Since almost all free moisture in lumber is removed, and a depressurizing step is carried out in a range in which the moisture content is 25% through 30% at which advancement of drying becomes slow, bound water in the lumber may be positively diffused to the surface, and the moisture may be removed in the dehumidifying step, wherein the drying time is shortened and it is possible to prevent lumber from being subjected to warping, internal cracking, breaking, shrinkage and bending.

(5) By depressurizing to −80 kPa through −97 kPa, all lumber may be uniformly dried regardless of unevenness in moisture content at the initial stage of respective lumber. Therefore, insufficiently dried lumber may be prevented from being brought about, and time control may be easily carried out.

(6) By carrying out a dehumidifying step, lumber may be dried until the target moisture content is gained in response to the type of lumber, wherein an uniformly dried state may be obtained.

Here, the moisture content is defined to be a value obtained by expressing the weight of contained moisture with the entire drying weight in terms of percentage.

The degree of depressurization differs according to the type of lumber and the locality thereof. By setting preferable drying conditions in response to the type of lumber and the locality, it is possible to securely prevent lumber from being subjected to warping, internal cracking, breaking, shrinkage, and bending.

It is preferable that the heating step is carried out in a range of 40° C. through 60° C. for the set temperature, and 60% through 95%, preferably 80% through 95% for the set humidity. If the set temperature becomes lower than 40° C. or the set humidity becomes higher than 95%, the heating becomes insufficient, wherein there is a tendency for the drying time to be lengthened. Also, if the set temperature becomes higher than 60° C. or the set humidity becomes lower than 80%, only the surface of lumber is apt to be dried, wherein there is a tendency for the lumber to be subjected to discoloring and for the commercial value thereof to be lowered. Further, if the set humidity is less than 60%, the above-described tendency becomes remarkable, and this is not favorable.

It is favorable that depressurization in the depressurizing step is −80 kPa through −97 kPa. If the depressurization is higher than −80 kPa, the boiling point in the drying chamber becomes higher than the set temperature in the heating step, wherein there is a tendency for the drying time to be lengthened. If lower than −97 kPa, the boiling point is remarkably lowered, wherein there is a tendency for only the surface to be apt to be rapidly dried. Either of them is not favorable.

It is preferable that the dehumidifying step is carried out at a temperature of 20° C. through 40° C. If the temperature becomes lower than 20° C., there is a tendency for the moisture content of the surface of lumber to become too low. If the temperature becomes higher than 40° C., there is a tendency for moisture on the surface of lumber not to be sufficiently absorbed and that it becomes difficult to dry lumber to the final moisture content which is the target. Either of them is not favorable.

Also, by measuring the initial moisture content of lumber before starting drying, the depressurization type drying machine may be controlled by the elapse time after starting the drying, and the operation may be automated by the time control, wherein the operation efficiency and productivity thereof may be improved.

For example, the target final moisture content is 15% or less where cedar (cryptomeria) and Japanese cypress (white cypress) are used as pillars or posts, 18% or less where they are used as beams, and 20% or less where they are used as groundsills.

Since lumber is dried at a comparatively low temperature in the depressurization type drying machine, water contained in the lumber may be extracted without any waste and may be effectively utilized as by-products.

For example, water (sap) extracted by drying lumber contains essential oil. In particular, essential oil extracted from cedar (cryptomeria) and Japanese cypress (white cedar) is antibacterial, and may be used as chemicals such as a deodorant, a fragrance additive, a deodorizer, an insect repellent, an athlete's foot remedy, and cosmetics, substitutions of agricultural chemicals for organic cultivation, composts, a growth promoting agent, and may be further used as a tranquilizer, that is, the essential oil is useful as by-products. Also, moisture from which essential oil is removed contains several hundreds of constituents. The water may be utilized as drinking water by refining, and may be expected for various uses. It is possible to extract approximately 500 kg of sap from 1000 kg of lumber such as cedar.

It is preferable that a dew condensation water drainpipe equipped with a drain cock is disposed on the floor portion of the drying chamber so as to communicate with the floor portion thereof. Accordingly, it is possible to drain dew condensation water generated by air in the drying chamber being brought into contact with the floor portion and the inner wall of the sidewall portion, wherein water contained in lumber may be extracted without any waste and may be effectively utilized.

A method for drying lumber according to a sixth aspect of the invention is a method for drying lumber according to the fifth aspect, which includes a step of giving vibrations to lumber loaded on the carriage by means of a vibration generating unit according to the fourth aspect in the depressurization step.

With the configuration, the following action is brought about in addition to the actions according to the fifth aspect.

(1) By giving vibrations to lumber loaded on the carriage by means of a vibration generating unit in the depressurizing step, moisture in the core portion of lumber may be diffused to the outer surface, and at the same time, air having high humidity, which exists on the surface of lumber, may be substituted by the ambient air. It is possible to uniformly dry lumber in a short time by synergic effects of heating, depressurizing and vibration.

Here, vibration of lumber by the vibration generating unit is controlled by the moisture content of lumber. For example, vibration in depressurization is stopped when the moisture content is 30% or less where the lumber is Japanese cypress (white cedar) and when the moisture content is 25% or less where the lumber is cedar. By giving vibrations when depressurizing, it is possible to prevent lumber from being cracked and to prevent occurred cracking from being promoted, wherein the yield may be increased, and it is possible to obtain a uniform and high quality dried state. The commercial value may be increased.

A method according to a seventh aspect of the invention is a method for drying lumber using a depressurization type drying machine according to the fifth aspect or the sixth aspect, which includes, as a post-step of the depressurizing step, a heating and humidifying step for humidifying to a humidity of 80% through 95% by means of the spraying unit according to the third aspect while heating the interior of the drying chamber to a temperature set in a range from 40° C. through 60° C. by the heater.

With the configuration, the following action is brought about in addition to the actions according to the fifth aspect or the sixth aspect.

(1) Since, as a post-step of the depressurizing step, the heating and humidifying step for humidifying to a humidity of 80% through 95% by means of the spraying unit is carried out, while heating the interior of the drying chamber to a temperature set in a range from 40° C. through 60° C. by the heater, it is possible to recover the temperature and humidity of the drying chamber, which are lowered by the depressurizing step, and it is possible to prevent only the surface from being dried by supplying moisture to the surface of lumber. The inside of the lumber and the surface thereof are uniformly dried with the drying balance secured, wherein it is possible to reduce the surface cracking.

Here, the heating and humidifying step is such that humidifying is carried out while heating so that the temperature and humidity of the interior of the drying chamber becomes roughly equivalent to those in the heating step.

A method according to a eighth aspect of the invention is a method for drying lumber according to the seventh aspect, which includes a configuration of repeating the depressurizing step and the heating and humidifying step.

With the configuration, the following action is brought about in addition to the action according to the seventh aspect.

(1) By intermittently carrying out the depressurizing step and the heating and humidifying step, uniformly drying may be efficiently executed in a short time while securing balance in drying between the interior of lumber and the surface thereof. Surface cracking may be effectively prevented from occurring, wherein the yield may be remarkably improved.

### EFFECTS OF THE INVENTION

As described above, according to a depressurization type drying machine of the invention, the following advantageous effects may be brought about.

The following effects may be brought about by the first aspect of the invention.

(1) Since the ceiling portion, sidewall portions, and floor portion of the drying chamber are formed to be a dual-structure composed of the outer wall and inner wall, and the system is provided with a sealing type door disposed at the front sidewall portion of the drying chamber and a heat insulation layer formed between the outer wall and the inner wall, the system may increase the efficiency when cooling and heating the interior of the drying chamber by controlling heat radiation from the drying chamber and heat absorption from the exterior of the drying chamber. Therefore, it is possible to provide a depressurization type drying machine having an excellent energy-saving properties and excellent reliability, by which the temperature in the drying chamber is stably maintained at a low temperature.

(2) Since the ceiling portion and sidewall portions are formed roughly like a circular arc swelled outwardly, it is possible to provide a depressurization type drying machine, having excellent durability, in which the ceiling portion and sidewall portions are only resiliently deformed even by depressurizing the interior of the drying chamber, wherein no plastic deformation occurs, and even if depressurization is repeated, the drying chamber is not broken.

(3) Since reinforcement ribs are provided, which are disposed along the outer circumference of the inner wall parallel to and/or in orthogonal to the lengthwise direction of the drying chamber between the respective outer walls and inner walls of the ceiling portion, the sidewall portions, and the floor portion, it is possible to provide a depressurization type drying machine, having excellent productivity, in which the outer walls and inner walls are firmly supported by means of the reinforcement ribs, wherein since the ceiling portion and the sidewall portions may be securely prevented from being deformed, the interior of the drying chamber may be depressurized at a high pressure, and the material may be uniformly dried in a short time.

(4) Since the ceiling portion and the sidewall portions of the drying chamber are formed to be roughly like a circular arc swelled outwardly, it is possible to provide a depressurization type drying machine, having an excellent treatment capacity, in which rectification of air may be made favorable in the interior of the drying chamber, and the capacity of the drying chamber may be increased.

(5) It is possible to provide a depressurization type drying machine having high quality, that, since the dehumidifier is disposed at the rear wall side of the drying chamber, the rectification plate is disposed on the ceiling portion apart from the inner wall, and the ceiling air path is formed, is capable of stirring air in the drying chamber by the air circulating unit disposed at the ceiling portion while circulating the same, is capable of covering up the entirety of the materials to be dried with dry air jetted from a plurality of air pores drilled in the rectification plate, is capable of keeping the interior of the drying chamber on uniform drying conditions, and is capable of, in particular when drying lumber, preventing the lumber from being subjected to warping, internal cracking, breaking, shrinkage, bending, etc.

(6) It is possible to provide a depressurization type drying machine having excellent productivity and reliability, which, since the outdoor vacuum pump is provided, is capable of drying materials to be dried by depressurizing the interior of the drying chamber, and diffusing humidity in the core portions of the materials to be dried with the temperature in the drying chamber kept at a low temperature, is capable of shortening the drying time and uniformly drying the materials to be dried, and in particular when drying lumber, is capable of preventing the lumber from being subjected to warping, internal cracking, breaking, shrinkage, and bending, etc.

(7) It is possible to provide a depressurization type drying machine having excellent productivity and high quality, which, since the air circulating unit is provided with air pipes connected to the blower and disposed in parallel to the lengthwise direction of the drying chamber at both sides of the ceiling portion, is capable of stirring air in the drying chamber without any irregularity by jetting air from a plurality of air pores drilled in the air pipes, is capable of drying the materials to be dried without any irregularity with the atmosphere in the drying chamber made uniform, and in particular when drying lumber, is capable of effectively preventing lumber from being subjected to end cracking, warping, bending, etc.

(8) It is possible to provide a depressurization type drying machine having excellent productivity, which, since the interior of the drying chamber is depressurized by the outdoor vacuum pump, is capable of heating the interior of the drying chamber over the boiling point by a heater with the boiling point lowered, and is capable of shortening the drying time.

(9) It is possible to provide a depressurization type drying machine having excellent productivity and versatility, which is capable of easily heating the interior of the drying chamber by a heater, shortening the drying time, and even in a cold district or when the ambient temperature is low in winter time, is capable of keeping the interior of the drying chamber steadily at a fixed temperature set in advance, and is capable of reducing unevenness in the drying time and the drying conditions.

According to the second aspect of the invention, the following effects may be brought about in addition to those according to the first aspect.

(1) Since the depressurization type drying machine is provided with a temperature sensor for measuring the temperature in the drying chamber, a humidity sensor for measuring the humidity in the drying chamber, and a pressure sensor for measuring the pressure in the drying chamber, it is possible to provide a depressurization type drying machine, having excellent reliability, which may monitor the status in the drying chamber and may set the optimal drying conditions.

According to the third aspect of the invention, the following effects may be brought about in addition to the first aspect or the second aspect thereof.

(1) Since the humidity in the drying chamber, which is lowered by depressurization, may be restored by spraying moisture in a mist form by the spraying unit, it is possible to provide a depressurization type drying machine, having high yield and productivity, which is capable of preventing the material from being dried only on the surface by supplying moisture onto the surface of the material to be dried, and enabling uniformly drying of the entirety of the material to be dried with balance taken in drying between the interior of the material and the surface thereof, and in particular when drying lumber, effectively reducing occurrence of the surface cracking.

(2) Since the spraying unit is provided at the front sidewall portion side, it is possible to provide a depressurization type drying machine having excellent reliability, which is capable of uniformly maintaining the humidity in the drying chamber by diffusing moisture from mist sprayed by the spraying unit to the entirety of the drying chamber in line with circulation and stirring of air by means of the air circulating unit.

According to the fourth aspect of the invention, the following effects may be brought about in addition to any one of the first aspect through the third aspect thereof.

(1) Since vibrations may be given to the materials to be dried, by the vibration generating unit disposed on the carriage, it is possible to provide a depressurization type drying machine having excellent productivity and excellent drying efficiency, which is capable of positively stirring and exchanging air absorbing moisture in the vicinity of the surface of the materials and the atmospheric air, and drying the materials to be dried in a short time.

(2) Since, after the interior of the drying chamber is heated by the heater, the drying chamber is depressurized by the outdoor vacuum pump, vibrations are given to the materials in a state where the boiling point is lowered not exceeding the temperature in the drying chamber, it is possible to provide a depressurization type drying machine having excellent productivity and reliability, which is capable of drying by positively diffusing moisture in the core portion to the surface, and carrying out uniformly drying in a short time by an synergistic effect of heating and depressurized vibrations.

According to the fifth aspect of the invention, the following effects may be brought about.

(1) Since the heating step, the depressurizing step and the dehumidifying step are provided, it is possible to provide a method for drying lumber using a depressurization type drying machine having excellent productivity and versatility, which is capable of varying the drying conditions according to the drying state of lumber, and efficiently drying the lumber.

(2) Since the drying step is carried out at a comparatively low temperature of 40° C. through 60° C., it is possible to provide a method for drying lumber using a depressurization type drying machine having excellent reliability and high quality, which is capable of leaving essential oil contents, preventing lumber from being subjected to warping, internal cracking, breaking, shrinkage, bending and discoloring with dried lumber hardly damaged, providing dried lumber with durability and anti-corrosion properties, and enhancing the commercial value with gloss remained on the surface thereof and scent remained after drying.

(3) Since a depressurizing step for depressurizing the interior of the drying chamber to −80 kPa through −97 kPa is carried out after the heating step is completed, it is possible to provide a method for drying lumber using a depressurization type drying machine having excellent productivity and practicability, which is capable of lowering the boiling point less than the temperature of the interior of the drying chamber, and drying in a short time even at a low temperature.

(4) Since almost all free moisture in lumber is removed, bound water in the lumber is positively diffused to the surface by carrying out a depressurizing step in a range in which the moisture content is 25% through 30% at which advancement of drying becomes slow, and the moisture may be removed in the dehumidifying step, it is possible to provide a method for drying lumber using a depressurization type drying machine having excellent productivity and high quality, which is capable of shortening the drying time, and preventing lumber from being subjected to warping, internal cracking, breaking, shrinkage and bending.

(5) It is possible to provide a method for drying lumber using a depressurization type drying machine having excellent versatility, productivity and operability, which is capable of uniformly preventing lumber regardless of unevenness in moisture content at the initial stage of respective lumber by depressurizing to −80 kPa through −97 kPa, preventing insufficiently dried lumber from occurring, and easily carrying out the time control.

(6) It is possible to provide a method for drying lumber using a depressurization type drying machine having excellent versatility and high quality, which is capable of drying lumber by carrying out a dehumidifying step until a target moisture content is obtained in response to the type of lumber, and acquiring an uniformly dried state.

According to the sixth aspect of the invention, the following effect may be brought about in addition to the effects of the fifth aspect thereof.

(1) Since vibrations are given to lumber loaded on the carriage by means of a vibration generating unit in the depressurizing step, it is possible to provide a method for drying lumber using a depressurization type drying machine having excellent quality, which is capable of diffusing moisture in the core portion of lumber to the outer surface, and at the same time, displacing air of high humidity, which exists on the surface of lumber, by the ambient air, and uniformly drying lumber in a short time by synergic effects of heating, depressurizing and vibration.

According to the seventh aspect of the invention, the following effect may be brought about in addition to the effects according to the fifth aspect or the sixth aspect thereof.

(1) Since the heating and humidifying step is carried out as a post-step of the depressurizing step, it is possible to provide a method for drying lumber using a depressurization type drying machine having high yield and excellent productivity, which is capable of maintaining the interior of the drying chamber in a range of temperature from 40° C. through 60° C. and of humidity of 80% through 95%, preventing only the surface from being dried by supplying moisture to the surface of lumber, uniformly drying the interior of lumber and the surface thereof with the drying balance secured, and effectively reducing occurrence of surface cracking.

According to the eighth aspect of the invention, the following effect may be brought about in addition to the effect of the seventh aspect.

(1) Since the depressurizing step and the heating and humidifying step are repeatedly carried out, it is possible to provide a method for drying lumber using a depressurization type drying machine having excellent reliability, which is capable of efficiently and uniformly drying lumber in a short time with the drying balance secured between the interior of lumber and the surface thereof, and reducing the occurrence ratio of surface cracking to 5% or less.

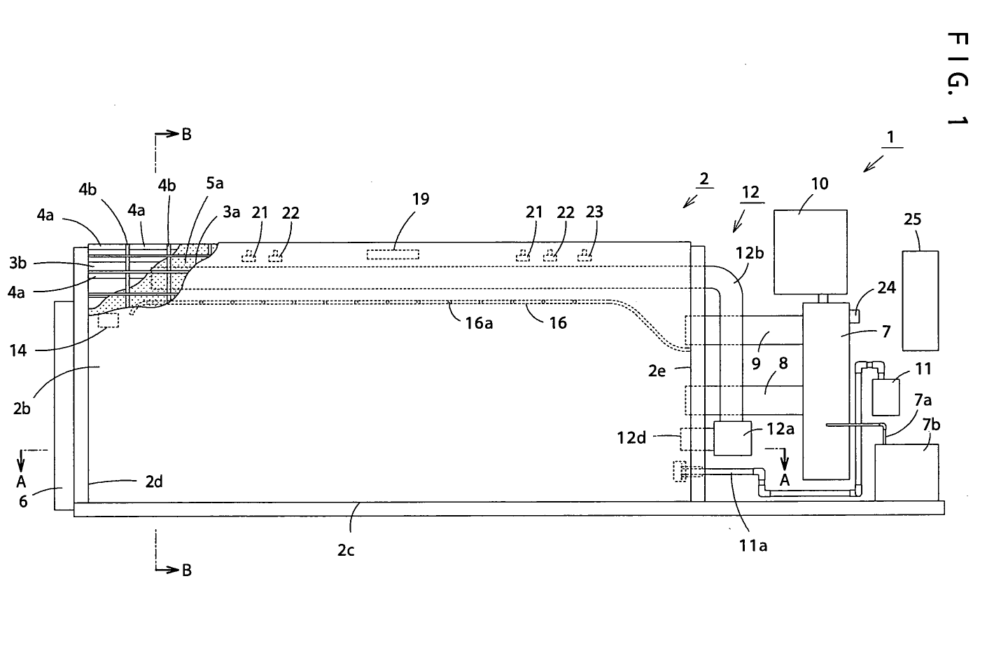

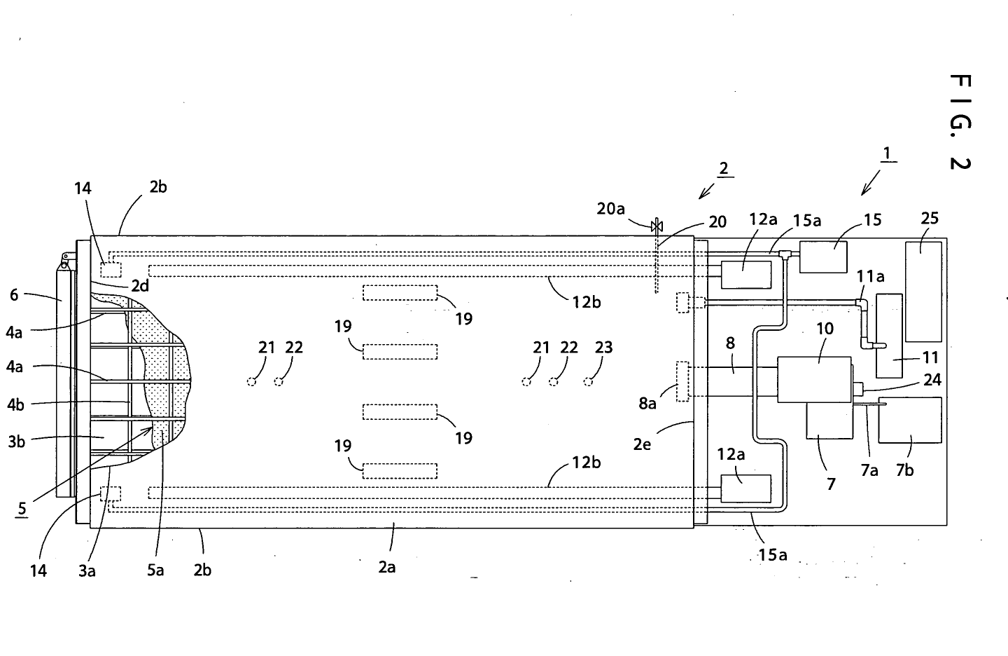

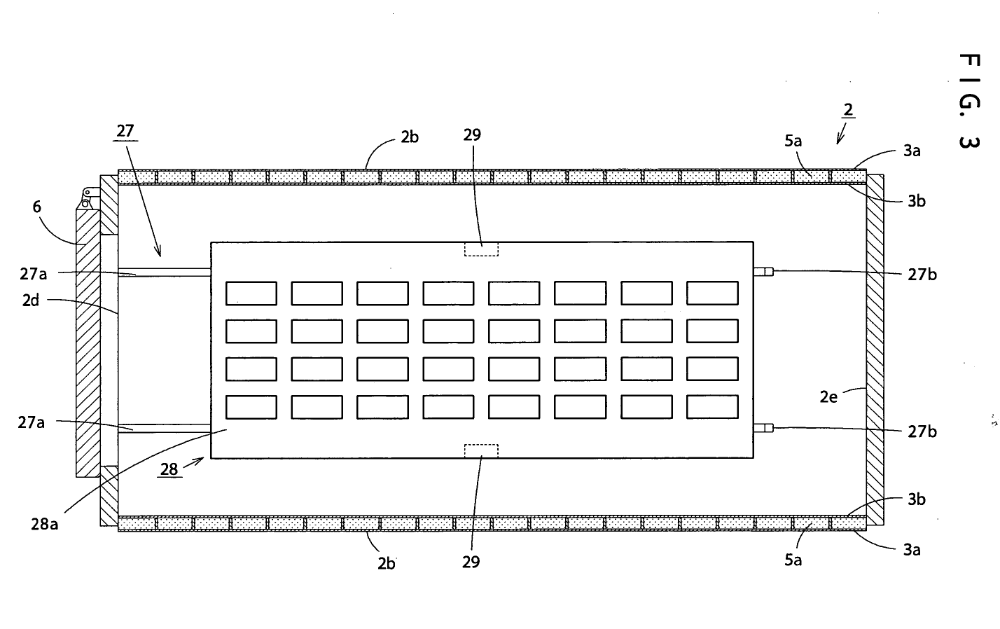

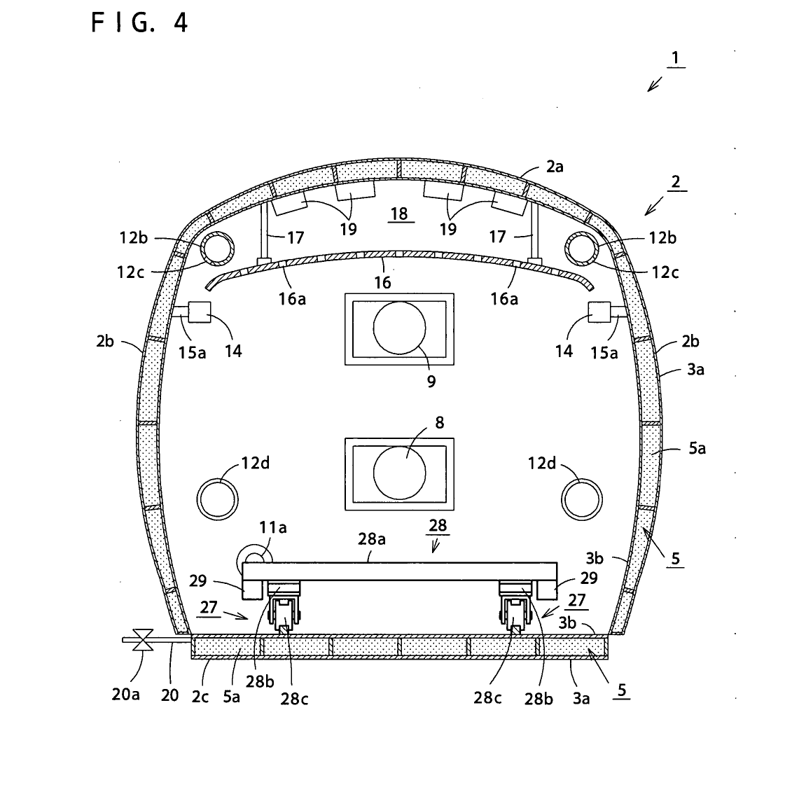

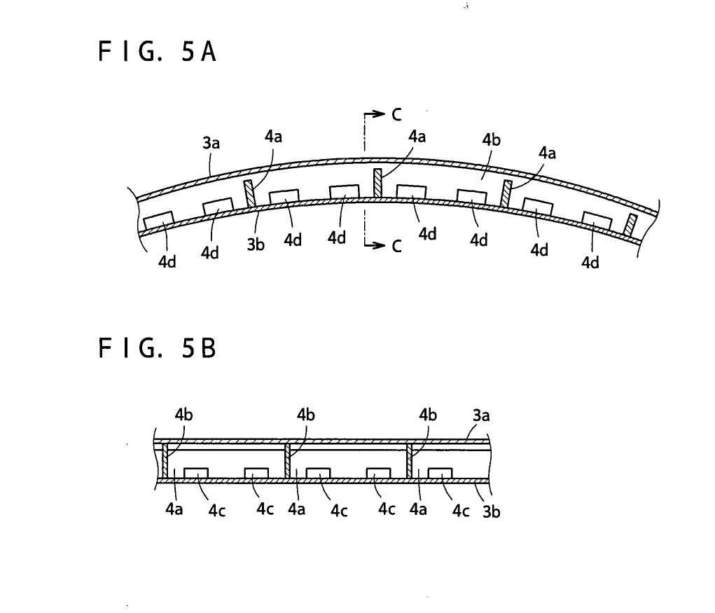

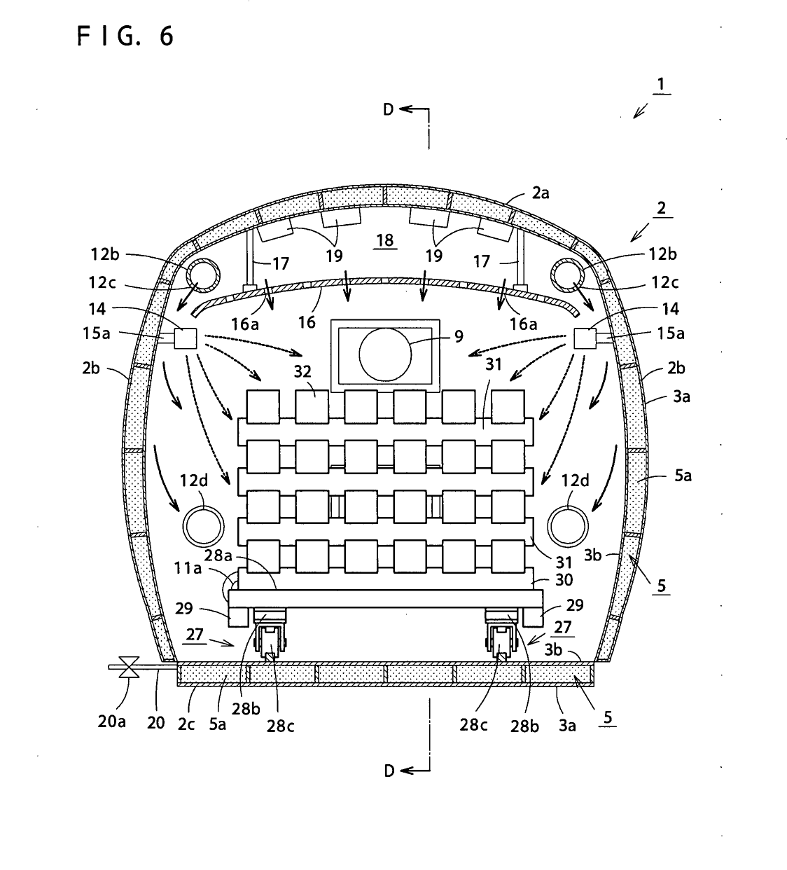

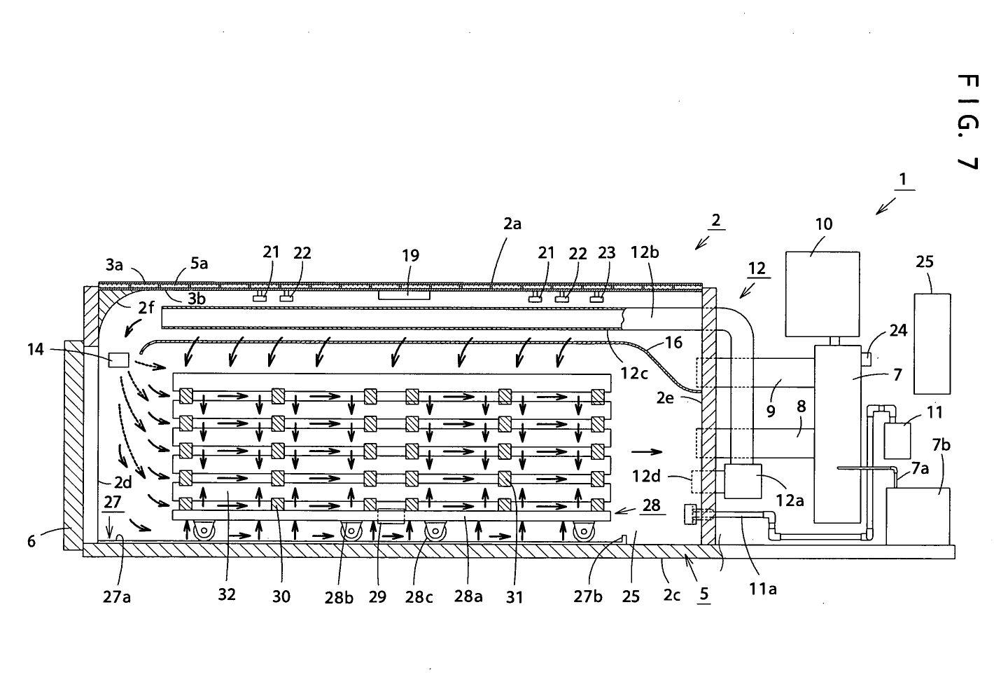

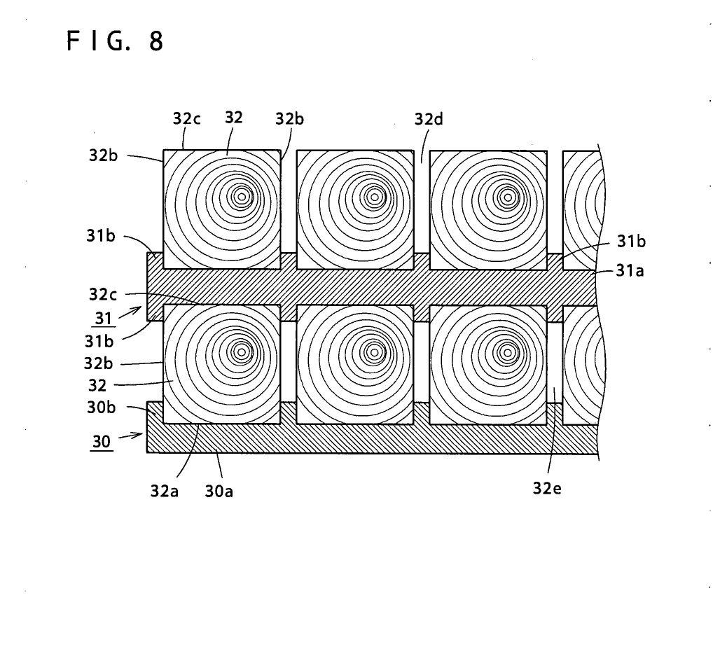

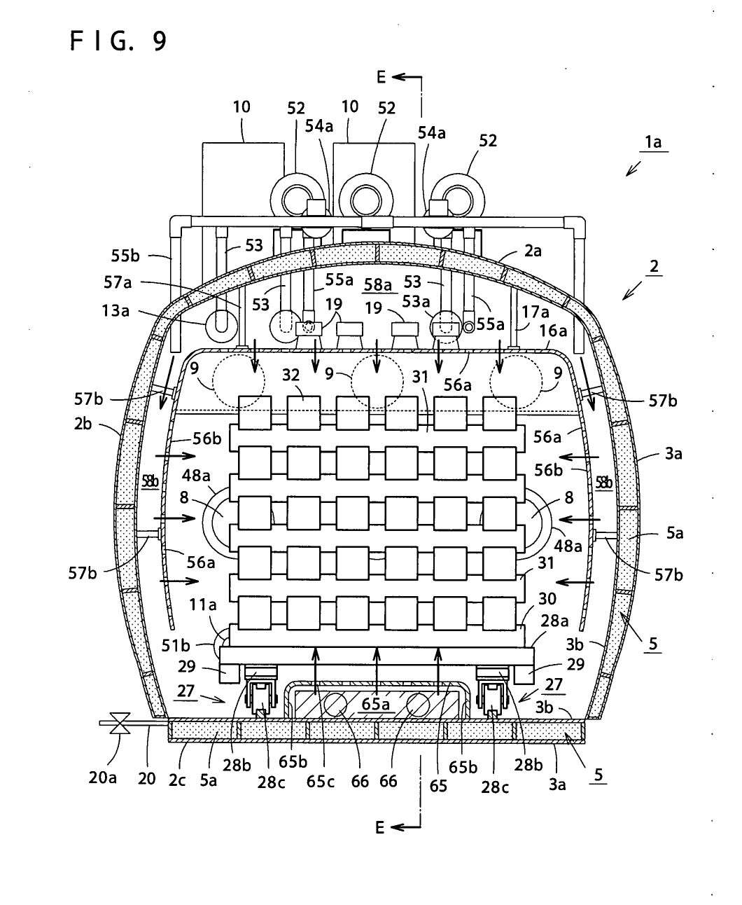

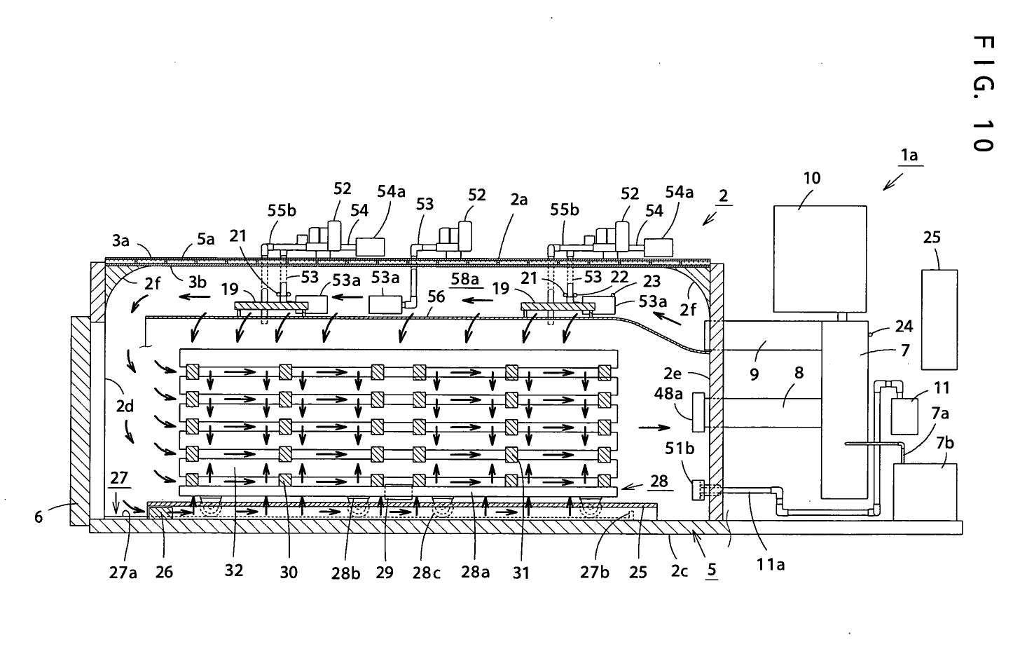

### BRIEF DESCRIPTION OF THE DRAWINGS

[FIG. 1] is a partially broken perspective side view showing the major parts of a depressurization type drying machine according to Embodiment 1 of the invention;

[FIG. 2] is a partially broken perspective plan view showing the major parts of Embodiment 1 of the invention;

[FIG. 3] is a sectional plan view taken along the line A-A of FIG. 1;

[FIG. 4] is a sectional front view taken along the line B-B of FIG. 1;

[FIG. 5](a) is an enlarged front sectional view showing the structure of reinforcement ribs, and [FIG. 5](b) is a sectional side view taken along the line C-C of FIG. 5(a);

[FIG. 6] is a sectional front view of the major parts, showing a drying state of lumber according to a depressurization type drying machine according to Embodiment 1 of the invention;

[FIG. 7] is a sectional side view taken along the line D-D of FIG. 6;

[FIG. 8] is an enlarged front view of the major parts, showing a loaded state of lumber;

[FIG. 9] is a sectional front view of the major parts, showing a drying state of lumber in a depressurization type drying machine according to Embodiment 2; and

[FIG. 10] is a sectional view side taken along the line E-E of FIG. 9.

### DESCRIPTION OF REFERENCE NUMERALS

1,1a Depressurization type drying machine
2 Drying chamber
2a Ceiling portion
2b Sidewall portion
2c Floor portion
2d Front sidewall
2e Rear sidewall
3a Outer wall
3b Inner wall
4a,4b Reinforcement ribs
4c,4d Notched portions
5 Heat insulation layer
5a Heat insulating material
6 Door
7 Dehumidifier
7a Drainpipe
7b Water intake tank
8 Suction-duct
8a Air filter
9 Air feeding duct
10 Outdoor unit
11 Outdoor vacuum pump
11a Depressurization pipe
12 Air circulating unit
12a Blower
12b Air pipe
12c Air jetting pore
12d Inlet pipe
14 Spraying unit
15 Compressor
16 Rectification plate
16a Air pore
17 Fixing means
18 Ceiling air path
19 Heater
20 Dew condensation water drainpipe
20a Drain cock
21 Temperature sensor
22 Humidity sensor
23 Pressure sensor
24 Outdoor temperature sensor
25 Control portion
27 Carriage guiding portion
27a Rail portion
27b Stopper portion
28 Carriage
28a Loading plate
28b resilient body
28c Wheels
29 Vibration generating unit
30 Lower stage fixture
30a Flat plate portion
30b Supporting portion
31 Intermediate fixture
31a Flat plate portion
31b Supporting portion
32 Lumber
32a Bottom
32b Side
32c Upper side
32d Clearance
48a, 51b, 54a Air filter
52 Blower
53 Inlet pipe
54 Ambient air inflow pipe
55a Exhaust pipe
55b Air feeding pipe
56a Top plate for rectification
56b Side plate for rectification
56c, 56d, 65c Air pores
57a, 57b Fixing means
58a Ceiling air path
58b Sidewall air path
65 Floor plate for rectification
65a Floor air path
65b Leg portion
66 Blower for floor

### DETAILED DESCRIPTION OF THE INVENTION

### Embodiment 1

A description is given below of a depressurization type drying machine according to Embodiment 1 of the invention with reference to the accompanying drawings.

FIG. 1 is a partially broken perspective side view showing the major parts of a depressurization type drying machine according to Embodiment 1 of the invention, FIG. 2 is a partially broken perspective plan view showing the major parts of Embodiment 1 of the invention, FIG. 3 is a sectional plan view taken along the line A-A of FIG. 1, and FIG. 4 is a sectional front view taken along the line B-B of FIG. 1.

In FIG. 1 through FIG. 4, reference numeral 1 denotes a depressurization type drying machine according to Embodiment 1 of the invention. Reference numeral 2 denotes a drying chamber in which the ceiling portion 2a, sidewall portions 2b and floor portion 2c shown in FIG. 4 are formed to be a dual structure consisting of the outer wall 3a and the inner wall 3b. Reference numerals 4a and 4b denote lattice reinforcement ribs disposed along the outer circumference of the inner wall 3b parallel to and in orthogonal to the lengthwise direction of the drying chamber 2. Reference numeral 5 denotes a heat insulation layer that is surrounded by the reinforcement ribs 4a and 4b between the outer wall 3a and the inner wall 3b and is formed of a heat insulating material 5a, such as glass wool and foamed polyurethane, covered on the inner wall 3b. Reference numeral 6 denotes a sealing type door disposed at the front sidewall 2d portion of the drying chamber 2. Reference numeral 7 denotes a dehumidifier interconnected to the exterior of the drying chamber 2 at the rear wall 2e side to dehumidify and dry the interior of the drying chamber 2. Reference numeral 7a denotes a drainpipe connected to the dehumidifier 7 to drain water extracted by the dehumidifier 7, and 7b denotes a water intake tank to extract water drained through the drainpipe 7a. Reference numeral 8 denotes a suction duct that connects the interior of the drying chamber 2 and the dehumidifier 7 to each other and takes air in the drying chamber 2 into the dehumidifier 7. Reference numeral 9 denotes an air feeding duct that connects the interior of the drying chamber 2 and the dehumidifier 7 to each other and sends off dry air into the drying chamber 2. Reference numeral 10 denotes an outdoor unit interconnected to the dehumidifier 7. Reference numeral 11 denotes an outdoor vacuum pump interconnected to the drying chamber 2 via a depressurization pipe 11a to depressurize the interior of the drying chamber 2. Reference numeral 12 denotes an air circulating unit, 12a denotes a blower of the air circulating unit 12, which is disposed at the exterior of the drying chamber 2 at the rear wall 2e side, 12b denotes an air pipe of the air circulating unit 12, which is connected to the blower 12a and is disposed parallel to the lengthwise direction of the drying chamber 2 at both sides of the ceiling portion 2a, 12c denotes a plurality of air jetting pores (FIG. 4) drilled in the lengthwise direction of the air pipe 12b, and 12d denotes an inlet pipe of the air circulating unit 12, which is interconnected to the rear side wall of the drying chamber 2 and is connected to the blower 12a. As shown in FIG. 4, reference numeral 14 denotes a spraying unit disposed at the left and right sidewall portions 2b at the front sidewall portion 2d side of the drying chamber 2. Reference numeral 15 denotes a compressor that is disposed at the exterior of the drying chamber 2 at the rear wall 2e side and is connected to the spraying unit 14 via a spraying pipe 15a. Reference numeral 16 denotes a rectification plate (FIG. 4) that is suspended from and fixed at the inner wall 3b of the ceiling portion 2a with predetermined clearance therefrom by fixing means 17 such as bolts and nuts and forms a ceiling air path 18, and 16a denotes a plurality of air pores (FIG. 1 and FIG. 4) that are drilled in the rectification plate 16 and jets air in the ceiling air path 18 toward the interior of the drying chamber 2. Reference numeral 19 denotes a heater (FIG. 1 and FIG. 4) that is disposed on the inner wall 3b of the ceiling portion 2a and heats the interior of the drying chamber 2. Reference numeral 20 denotes a dew condensation water drainpipe that is provided with a drain cock 20a, is disposed so as to communicate with the inner wall 3b of the floor portion 2c, and drains dew condensation water generated on the sidewall portions 2b of the drying chamber 2 and on the inner wall 3b of the floor portion 2c. Reference numeral 21 denotes a temperature sensor that is disposed at the front sidewall 2d side of the drying chamber 2 and at the rear sidewall 2e side thereof and measures the temperature in the drying chamber 2. Reference numeral 22 denotes a humidity sensor that is installed along with the temperature sensor 21 and measures the humidity in the drying chamber 2. Reference numeral 23 denotes a pressure sensor that is disposed in the vicinity of the temperature sensor 21 and the humidity sensor 22 at the rear sidewall 2e side and measures the pressure in the drying chamber 2. Reference numeral 24 denotes an outdoor temperature sensor that is disposed at the dehumidifier 7 and measures the atmospheric air temperature. Reference numeral 27 denotes a carriage guiding portion that is disposed on the inner wall 3b of the floor portion 2c and guides the carriage 28 on which materials to be dried are loaded, 27a denotes a rail portion, the section of which is roughly rectangular, of the carriage guiding portion 27, which is engaged with a grooved portion of a wheel 28c of the carriage 28, and 27b denotes a stopper portion of the carriage guiding portion 27, which stops and/or fixes the carriage 28 at a predetermined position. Reference numeral 28a denotes a loading plate, which is formed to be lattice-like, of the carriage 28 on which materials to be dried are loaded, 28c denotes wheels disposed by two or more in the lengthwise direction of both side portions of the bottom of the loading plate 28a, respectively, by means of resilient bodies 28b such as synthetic rubber, etc. Reference numeral 29 denotes an electro-turning type vibration generating unit that is disposed at the middle part in the lengthwise direction at both sides of the bottom of the loading plate 28a of the carriage 28.

In the present embodiment, the drying chamber 2 is formed so that the outer shape thereof is approximately 2.4 m wide, approximately 2.5 m high, approximately 5 m long, and the internal volume thereof becomes approximately 20 cubic meters.

The ceiling portion 2a and the sidewall portions 2b of the drying chamber 2 are formed to be roughly like a circular arc swelled outward, and at the same time, lattice reinforcement ribs 4a and 4b are disposed between the outer wall 3a and the inner wall 3b, which form the drying chamber 2. Therefore, the pressure resistance of the drying chamber is improved, wherein depressurization to −97 kPa is enabled.

The critical meanings of figures described below changes in compliance with the size of an apparatus. However, in the drying chamber 2 according to the present embodiment, the plates of the outer wall 3a, inner wall 3b and reinforcement ribs 4a and 4b were formed to be 6 mm through 9 mm thick. If the plate thickness becomes thinner than 6 mm, the strength thereof is lowered, wherein the drying chamber 2 is subjected to deformation when being depressurized, and there is a tendency for durability and reliability thereof to be lowered. Also, if thicker than 9 mm, the weight is increased and becomes difficult to be handled, wherein there is a tendency for workability and productivity to be lowered.

The pitch of disposing the reinforcement ribs 4a and 4b was formed to be 450 mm through 600 mm in both the lengthwise direction and the circumferential direction of the drying chamber 2. If the pitch becomes narrower than 450 mm, the number of working steps is increased, wherein the workability is lowered, and there is a tendency for the weight of the entire drying chamber 2 to be increased and for the production costs to be increased. If wider than 600 mm, the strength becomes short, wherein the drying chamber 2 is apt to be deformed when being depressurized, and there is a tendency for the durability and reliability to become insufficient.

By disposing a drain cock in the water intake tank 7b or providing a drain pump therein, it is possible to easily and securely extract water by, for example, storing a large quantity of extracted moisture in another vessel.

Also, an ambient air inflow pipe (not illustrated) may be provided in the drying chamber 2. By taking the atmospheric air into the interior of the drying chamber 2 through the ambient air inflow pipe, the drying chamber 2 may be quickly returned from a depressurized state to the atmospheric pressure, wherein it is possible to change over the operation for a subsequent process in a short time. In addition, by taking the atmospheric air into the interior of the drying chamber 2 through the ambient air inflow pipe after drying is completed, it is possible to cool down the drying chamber 2 heated. Therefore, entrance into the drying chamber 2 and exit therefrom are enabled in a short time, wherein since it is possible to check a drying state of materials to be dried and to take out the same, the operation efficiency is excellent.

A water-sealed type pump best suitable for exhaust of air containing steam and water drops was used as the outdoor vacuum pump 11. The temperature of the sealing water circulated and used by the water-sealed type pump was kept on 20° C. through 40° C. by a cooling unit (not illustrated). Accordingly, it is possible to prevent the exhaust speed from being lowered due to a rise in the water temperature, wherein the reliability and operation stability are excellent.

The air pipe 12b disposed at both sides of the ceiling portion 2a of the drying chamber 2 and the inlet pipe 12d installed at the rear sidewall 2e were connected to the blower 12a, and air in the drying chamber 2 was devised to be circulated.

In the present embodiment, the tubular diameter of the air pipe 12b was set to 120 mm, the diameter of the air jetting pores 12c was set to 30 mm, and the pitch of the air jetting pores 12c was set to 300 mm. However, These figures may be appropriately determined so as to obtain an quantity of air necessary in response to the capacity of the drying chamber 2.

In particular, where the capacity of the drying chamber 2 is large and the dimension in the lengthwise direction is long, it is preferable that the diameter of the air pipe 12b, the diameter of the air jetting pores 12c and the pitch thereof may be varied stepwise at the upstream side and the downstream side so that a roughly equivalent quantity of air may be obtained regardless of the places. In addition, where the air feeding duct 9 is connected to the air pipe 12b, the blower 12a and the inlet pipe 12d may be omitted. Further, a blower and a stirring unit to stir and circulate air in the drying chamber 2 to the ceiling portion 2a and the sidewall portions 2b may be employed as the air circulating unit 12 instead of the blower 12a and the air pipe 12b.

The air jetting pores 12c were drilled so as to be tilted outward of the drying chamber 2 so that jetted air may flow along the inner wall 3b of the drying chamber 2 (FIG. 4).

By alternately driving the blowers 12a connected to the air pipes 12b disposed at both sides of the ceiling portion 2, respectively, air may be jetted from only either one of the left and right air jetting pores 12c of the drying chamber 2, and it is possible to stir air in the drying chamber 2 clockwise or counterclockwise. By alternately jetting air from the left and right air pipes 12b, it is possible to prevent the drying state from differing at the left and right sides of the drying chamber 2, wherein the reliability is excellent.

The spraying unit 14 is connected to the compressor 15 provided with a water reservoir, and moisture may be made from mist by the pressure of the compressor 15. The number of the spraying units 14 may be appropriately selected in response to the sectional area of the drying chamber 2. By devising so that moisture from mist may be sprayed to the entirety from the ceiling portion 2a to the floor portion 2c, the humidity in the drying chamber 2 cab be kept uniform, wherein it is possible to prevent lumber from being subjected to surface drying.

The humidity in the drying chamber 2, which is adjusted by the spraying unit 14, was set to 80% through 95%. As the humidity becomes lower than 80%, evaporation on the surface is made quicker than the internal diffusion, thereby resulting in surface drying. The effect of humidification becomes insufficient, and in particular, in the case of lumber, the lumber is easily subjected to discoloring and surface cracking, wherein there is a tendency for the commercial value to be lowered. As the humidity becomes higher than 95%, there is a tendency for the drying time to be lengthened.

The rectification plate 16 was made of metal such as a stainless steel plate, and the air pores 16a were formed by machining laser.

The shape of the air pores 16a was made circular or slot-like. The diameter of the circle was formed to be 40 mm through 70 mm and the length of the slot was formed to be 50 mm through 80 mm. As the diameter of the circle becomes shorter than 40 mm or the length of the slot becomes shorter than 50 mm, sufficient quantity of air cannot be obtained, where there is a tendency for the drying to become slow. As the diameter of the circle becomes larger than 70 mm or the length of the slot becomes longer than 80 mm, a sufficient air velocity cannot be obtained, wherein there is a tendency for dry air to become difficult to be circulated in the drying chamber 2.

The pitch of air pores 16a was set to 200 mm through 350 mm. As the pitch becomes shorter than 200 mm, the air pores 16a becomes too dense, and a sufficient air velocity cannot be obtained, wherein there is a tendency for dry air to become difficult to be circulated in the drying chamber 2. As the pitch becomes longer than 350 mm, a sufficient quantity of air cannot be obtained, wherein there is a tendency for the drying to become slow.

By keeping the dimensions of the air pores 16a and the pitch thereof as described above, it is possible to appropriately control the velocity of air jetted from the air pores 16a and flows of air in the drying chamber 2, wherein the drying may be uniformly and efficiently carried out.

Further, the rectification plate 16 was disposed so that the rear end portion thereof comes to a lower position than the air feeding duct 9 at the rear sidewall 2e of the drying chamber 2. Therefore, dry air, which is exhausted from the air feeding duct 9 when dehumidifying and drying, may be securely guided to the ceiling air path 18, and dry air may be uniformly jetted from the air pores 16a so that the materials to be dried are covered.

A dew condensation water drainpipe 20 provided with the drain cock 20a was disposed so as to be caused to communicate with the floor portion 2c of the drying chamber 2 (FIG. 2 and FIG. 4). Therefore, it is possible to drain dew condensation water that is generated by air in the drying chamber 2 being brought into contact with the inner wall 3b of the sidewall portions 2b and the floor portion 2c, and water contained in the materials to be dried may be extracted without any waste. Further, the inner wall 3b of the floor portion 2c is inclined so that the connection portion between the floor portion 2c and the dew condensation water drainpipe 20 is made lower than the surrounding, thereby securely draining/water.

By disposing a plurality of temperature sensors 21 and humidity sensors 22 in the drying chamber 2, it became possible to measure the average temperature and humidity in the drying chamber 2. In addition, by measuring the pressure in the drying chamber 2 by the pressure sensor 23, the outdoor vacuum pump 11 may be securely controlled to depressurize the interior of the drying chamber 2. Further, since the atmospheric temperature may be measured by the outdoor temperature sensor 24, the atmospheric temperature may be compared with the temperature in the drying chamber 2, wherein the atmospheric air may be brought in the drying chamber 2 as necessary, and efficient temperature control may be carried out.

In FIG. 3, since the carriage guiding portion 27 includes a rail portion 27a for guiding the wheels 28c of the carriage 28 and a stopper portion 27b for stopping and/or fixing the carriage 28 at a predetermined position, the carriage 28 may be easily guided to a predetermined position in the drying chamber 2 and installed there, wherein it is possible to prevent the carriage 28 from being erroneously brought into collision with the inner wall 3b of the drying chamber 2, and excellent reliability and workability may be secured. Still further, the carriage 28 may be manually let in and out or may be automatically controlled by electric driving means provided in the drying chamber 2.

Also, the loading plate 28a of the carriage 28 was formed to be lattice-shaped. Therefore, air flown between the floor portion 2c of the drying chamber 2 and the bottom of the carriage 28 may be blown upward from the bottom of the materials to be dried, which are loaded on the loading plate 28a, wherein drying irregularities may be prevented from occurring, and further uniformly drying is enabled.

In FIG. 4, by disposing resilient bodies 28b between the bottom of the loading plate 28a of the carriage 28 and the wheels 28c, vibrations generated by the vibration generating unit 29 are prevented from being transmitted to the wheel 28c side of the carriage 28.

Where drying lumber in the present embodiment, a vibration generating unit 29 whose output is 0.75 kW through 1.5 kW was used, and vibrations whose amplitude is 0.5 mm through 1 mm were given to lumber. As the amplitude becomes smaller than 0.5 mm, the movement amount of highly humid air on the surface of the materials to be dried is apt to be lessened, wherein displacement between the highly humid air and the ambient air becomes insufficient, and there is a tendency for the drying time to be lengthened. As the amplitude becomes larger than 1 mm, the entirety of the materials to be dried greatly vibrates, wherein there is a tendency for the humidity to be insufficiently diffused.

Next, a detailed description is given of the structure of the reinforcement ribs.

FIG. 5(a) is an enlarged front sectional view showing the structure of reinforcement ribs, and FIG. 5(b) is a sectional side view taken along the line C-C of FIG. 5(a).

In FIG. 5, reference numeral 4c denotes a notched portion formed to be roughly rectangular at the inner wall 3b side of the reinforcement rib 4a that is disposed along the outer circumference of the inner wall 3b parallel to and in the lengthwise direction of the drying chamber 2, and 4d denotes a notched portion formed to be roughly rectangular at the inner wall 3b side of the reinforcement rib 4b that is disposed in the circumferential direction along the outer circumference of the inner wall 3b in orthogonal to the lengthwise direction of the drying chamber 2.

The notched portions 4c and 4d were formed to be roughly rectangular, the sizes of which are 50 mm long and 15 mm through 20 mm high, respectively, and disposed at 100 mm to 200 mm pitches. Therefore, it is possible to lessen the contact area between the inner wall 3b and the reinforcement ribs 4a and 4b, wherein thermal transmission from the interior of the drying chamber 2 to the reinforcement ribs 4a and 4b may be reduced, thereby improving the heat insulation efficiency. As the pitch of the notched portions 4c and 4d becomes narrower than 100 mm, the number of working steps is increased to lower the workability, and at the same time, the reinforcement rib 4a becomes insufficient in strength, and there is a tendency for breakage to easily occur. As the pitch thereof becomes wider than 200 mm, an improvement effect of the heat insulation efficiency is apt to be lowered due to a decrease in the thermal transmission. Either of them is not favorable.

In addition, although, in the present embodiment, the shape of the notched portions 4c and 4d is made roughly rectangular, it may be made roughly circular arc-like or triangular if the opening area equivalent thereto may be obtained without making short the rigidity of the reinforcement ribs 4a and 4b.

Next, a description is given of a method for using a depressurization type drying machine according to Embodiment 1, referring to the drawings.

FIG. 6 is a sectional front view of the major parts, showing a drying state of lumber according to a depressurization type drying machine according to Embodiment 1 of the invention, FIG. 7 is a sectional side view taken along the line D-D of FIG. 6, and FIG. 8 is an enlarged front view of the major parts, showing a loaded state of lumber.

In FIG. 6 and FIG. 7, reference numeral 30 denotes a lower stage fixture that is placed on the loading plate 28a of the carriage 28 at a predetermined interval and is formed of a wooden member or a foamed synthetic resin member to lineup and support a plurality of lumber 32 at the extremely lower stage. Reference numeral 31 denotes an intermediate fixture that is placed together with lumber 32 alternately at a predetermined interval and is formed of a wooden member or a foamed synthetic resin member to line up and support a plurality of lumber 32 at an upper stage and a lower stage.

In FIG. 8, reference numeral 30a denotes a flat plate portion of the lower stage fixture 30, which is formed to be like a long-sized plate, 30b denotes a supporting portion of the lower stage fixture 30, which is projected on the upper surface of the flat plate portion 30a at a predetermined interval and is brought into contact with the side 32b of the lumber 32, and 31a denotes a flat plate portion of the intermediate fixture 31, which is placed on the upper surface 32c of the lower stage lumber 32 and supports the bottom 32a of the upper stage lumber 32, 31b denotes a supporting portion of the intermediate fixture 31, which is projected on the bottom surface and the top surface of the flat plate portion 31a at a predetermined interval and is brought into contact with the side 32b of the lumber 32 placed on the bottom surface and the top surface of the flat plate portion 31a, and 32d denotes clearance between a plurality of lumber 32, which is formed at the left and at the right sides of a plurality of lumber 32, respectively, lined up and supported in the horizontal direction and the vertical direction by means of the lower stage fixture 30 and the intermediate fixture 31.

By disposing the lower stage fixture 30 and the intermediate fixture 31 by two or more according to the length of lumber 32 in the lengthwise direction thereof, it is possible to securely line up and support the lumber 32.

In addition, where the entirety of lumber 32 on the carriage 28 is tightened by band-like tightening member shaving flexibility such as rubber at a plurality of points, it is possible to securely prevent the lumber 32 from being collapsed due to vibrations. Since the tightening members have flexibility, the lumber 32 may be securely fixed where the lumber 32 is shrunk after drying, wherein the reliability and safety are promoted.

Hereinafter, referring to the drawings, a description is given of a method for drying lumber using a depressurization type drying machine according to Embodiment 1 of the invention, which is constructed as described above.

In FIG. 6 and FIG. 7, the door 6 of the drying chamber 2 is completely sealed after lumber 32 is loaded and stacked in layers on the carriage 28 using the lower stage fixture 30 and the intermediate fixture 31.

In the heating step, the interior of the drying chamber 2 is heated to a temperature set in a range from 40° C. to 60° C. by the heater 19. The heating is continued until the core portion of the lumber 32 reaches the set temperature, and the heating state is kept for several hours. At this time, the humidity in the drying chamber 2 is kept at a humidity of 80% through 95%. If the set temperature becomes lower than 40° C. or the set humidity becomes higher than 95%, the heating becomes insufficient, wherein there is a tendency for the drying time to be lengthened. If the set temperature becomes higher than 60° C. or the set humidity becomes lower than 80%, only the surface of the lumber 32 is apt to be dried, wherein there is a tendency for the lumber 32 to be discolored and the commercial value to be reduced.

In the heating step, the blowers 12a connected to the left and right air pipes 12b are alternately driven, atmospheric air in the drying chamber 2 is stirred clockwise and counterclockwise alternately, and the air in the drying chamber 2 is uniformly heated in a short time, whereby it is prevented that a difference occurs in the left and right dried states.

In the depressurization step after the heating step, the interior of the drying chamber 2 is depressurized to −80 kPa through −97 kPa by the outdoor vacuum pump 11. At this time, vibrations whose amplitude is 0.5 mm through 1 mm are given to lumber 32 loaded on the carriage 28 by the vibration generating unit 29 in response to the moisture content of the lumber 32. Also, the moisture content at which vibrations are given by the vibration generating unit 29 differs according to the type of lumber. For example, vibrations are stopped at the moisture content of 30% or less where the lumber 32 is Japanese cypress (white cedar), and also at the moisture content of 25% or less where the lumber 32 is cedar (cryptomeria), respectively. Further, by measuring in advance the initial moisture content of lumber 32 before commencing drying, it is possible to grasp the moisture content on the way of drying based on the elapse time from commencement of drying and the quantity of moisture extracted by the water intake tank 7b.

Since the temperature and humidity in the drying chamber 2 are lowered by latent heat in the depressurization step, a heating and humidifying step is carried out. In the heating and humidifying step, the interior of the drying chamber 2 is humidified to a humidity of 80% through 95% by the spraying unit 14 while heating the same to a temperature set in a range from 40° C. through 60° C. by the heater 19. In the heating and humidifying step, the blower 12a is driven as in the above-described heating step to stir air in the drying chamber 2 by means of the air pipes 12b. Accordingly, moisture from mist sprayed by the spraying unit 14 may be spread to the entirety of the drying chamber 2, wherein it is possible to keep the interior of the drying chamber 2 at uniform temperature and humidity.

By repeating the depressurization step and the heating and humidifying step several times, interior moisture is intermittently diffused to the surface of lumber 32, and surface cracking may be prevented from occurring.

Finally, in the dehumidifying step, the interior of the drying chamber 2 is dehumidified by the dehumidifier 7 at a temperature set in a range from 20° C. through 40° C., thereby adjusting the dried state of the surface.

The temperature, humidity, pressure and moisture content are set in advance in the control portion 25 in compliance with the type of materials to be dried such as lumber 32, wherein the dehumidifier 7, outdoor unit 10, outdoor vacuum pump 11, air circulating unit 12, spraying unit 14, heater 19 and vibration generating unit 29 are controlled based on the measurement values obtained from the respective sensors 21 through 24 and the programs stored therein.

Furthermore, the temperature in the drying chamber 2 may be kept with accuracy of ±1° C. through ±2° C. with respect to the set temperature.

Since the depressurization type drying machine according to Embodiment 1 is constructed as described above, the following actions may be brought about.

(1) Since the ceiling portion 2a, side wall portions 2b, and floor portion 2c of the drying chamber 2 are formed to be a dual-structure composed of the outer wall 3a and inner wall 3b, and the system is provided with a sealing type door 6 disposed at the front sidewall 2d portion and a heat insulation layer 5 formed by disposing a heat insulating material 5a between the outer wall 3a and the inner wall 3b, the system may increase the efficiency when cooling and heating the interior of the drying chamber 2 by controlling heat radiation from the drying chamber 2 and heat absorption from the exterior of the drying chamber 2, and at the same time, the temperature in the drying chamber 2 is stabilized and is maintained at a fixed level.

(2) Since the ceiling portion 2a and sidewall portions 2b are formed roughly like a circular arc swelled outwardly, the ceiling portion 2a and sidewall portions 2b are only resiliently deformed even by depressurizing the interior of the drying chamber 2, wherein no plastic deformation occurs. Therefore, even if depressurization is repeated, the drying chamber 2 is not broken, and is excellent in durability.

(3) Since lattice-like reinforcement ribs 4a and 4b are provided, which are disposed along the outer circumference of the inner wall 3b parallel to and/or in orthogonal to the lengthwise direction of the drying chamber 2 between the respective outer walls 3a and inner walls 3b of the ceiling portion 2a, the sidewall portions 2b, and the floor portion 2c, the outer walls 3a and inner walls 3b are firmly supported by means of the reinforcement ribs 4a and 4b, wherein the ceiling portion 2a and the sidewall portions 2b may be reliably prevented from being deformed, and the interior of the drying chamber 2 may be depressurized at a high pressure. Therefore, it is possible to uniformly dry the material in a short time.

(4) Since the dehumidifier 7 is disposed at the rear sidewall 2e side of the drying chamber 2, the rectification plate 16 is disposed on the ceiling portion 2a apart from the inner wall 3b, and the ceiling air path 18 is thereby formed, air in the drying chamber 2 is stirred while being circulated by the air circulating unit 12 disposed in the ceiling portion 2a, and at the same time, air jetted from a plurality of air pores 16a drilled in the rectification plate 16 may cover the materials to be dried such as lumber 32 therewith. Accordingly, uniformly drying conditions may be kept in the drying chamber 2, and in particular when drying lumber 32, it is possible to prevent the lumber 32 from being subjected to warping, internal cracking, breaking, shrinkage and bending.

(5) Since the outdoor vacuum pump 11 is provided, the interior of the drying chamber 2 is depressurized, and it is possible to dry the materials to be dried while diffusing moisture in the core portion of the material to be dried such as lumber 32 with the temperature in the drying chamber 2 kept at a low temperature. Therefore, the drying time may be shortened, and the materials may be uniformly dried. Particularly when drying lumber 32, it is possible to prevent the lumber 32 from being subjected to warping, internal cracking, breaking, shrinkage, bending, etc.

(6) Since the air circulating unit 12 is provided with air pipes 12b connected to the blower 12a and disposed parallel to and in the lengthwise direction of the drying chamber 2 at both sides of the ceiling portion 2b, air is jetted through a plurality of air jetting pores 12c drilled in the air pipes 12b to stir air in the drying chamber 2, wherein the atmospheric air in the drying chamber 2 may be uniformly stirred so as to equalize the atmospheric air in the drying chamber 2, and it is possible to prevent drying irregularity from occurring.

(7) Since the air pipes 12b are disposed parallel to and in the lengthwise direction of the drying chamber 2 at both sides of the ceiling portion 2a, it is possible to stir the entire air in the drying chamber 2 without making any irregularity, wherein the materials to be dried may be uniformly dried, regardless of places. Particularly when drying lumber 32, it is possible to effectively prevent end cracking, warping and bending from occurring.

(8) Since the spraying unit 14 is provided, it is possible to restore the humidity in the drying chamber 2, which is lowered by depressurization, and humidity is supplied to the surface of a material to be dried, wherein the material is prevented from being dried only on the surface, and balance is taken in drying between the interior of the material to be dried and the surface thereof, thereby enabling uniformly drying of the entirety of the material to be dried. In particular, when drying lumber 32, it is possible to effectively prevent surface cracking from occurring.

(9) Since the spraying unit 14 is provided at the front sidewall 2d side, moisture from mist sprayed from the spraying unit 14 is diffused in the entirety of the drying chamber 2 in line with circulation and stirring of air by means of the air circulating unit 12, wherein it is possible to uniformly keep the humidity in the drying chamber 2.

(10) The interior of the drying chamber 2 may be easily heated by the heater 19, and the drying time may be shortened. Further, even in a cold district or where the ambient temperature is low in winter time, it is possible to reliably keep the interior of the drying chamber 2 at a constant set temperature, wherein it is possible to reduce unevenness in the drying time and the drying conditions.

(11) Since the carriage 28 on which the materials to be dried such as lumber 32 are loaded may be let in and out of the interior of the drying chamber 2, it is possible to load and unload the materials to be dried outside the drying chamber 2, wherein the materials to be dried such as lumber 32 having considerable weight may be easily conveyed.

(12) Since vibrations may be given to the materials to be dried such as lumber 32, by the vibration generating unit 29 disposed on the carriage 28, air absorbing moisture and the atmospheric air are positively stirred and exchanged in the vicinity of the surface of the materials to be dried. Therefore, the materials to be dried may be dried in a short time.

(13) After the interior of the drying chamber 2 is heated by the heater 19, the drying chamber 2 is depressurized by the outdoor vacuum pump 11, wherein by giving vibrations to the materials to be dried in a state where the boiling point is lowered less than the temperature in the drying chamber 2, moisture in the core portion may be positively diffused to the surface, and uniformly drying may be carried out in a short time by an synergistic effect of heating and depressurized vibrations.

(14) Since the system includes the temperature sensor 21 to measure the temperature in the drying chamber 2, the humidity sensor 22 to measure the humidity in the drying chamber 2 and the pressure sensor 23 to measure the pressure in the drying chamber 2, the status in the drying chamber 2 may be monitored, wherein the optimal drying conditions may be established.

Since the method for drying lumber using a depressurization type drying machine according to Embodiment 1 is configured as described above, the following actions may be brought about.

(1) Since the heating step, the depressurizing step and the dehumidifying step are provided, the drying conditions are varied according to the drying state of lumber 32, and the lumber 32 may be efficiently dried.

(2) Since the heating step is carried out at a comparatively low temperature of 40° C. through 60° C., essential oil contents may remain, wherein dried lumber 32 is hardly damaged, and the lumber 32 is prevented from being subjected to warping, internal cracking, breaking, shrinkage, bending and discoloring. Therefore, the durability and anti-corrosion properties thereof are excellent. Gloss remains on the surface thereof, and scent still remains after dried. Therefore, the commercial value of the lumber 32 may be increased.

(3) Since a depressurizing step for depressurizing the interior of the drying chamber 2 to −80 kPa through −97 kPa is carried out after the heating step is completed, the boiling point may be lowered less than the temperature of the interior of the drying chamber 2, wherein it is possible to dry in a short time even at a low temperature.

(4) Since almost all free moisture in lumber 32 is removed, and a depressurizing step is carried out in a range in which the moisture content is 25% through 30% at which advancement of drying becomes slow, bound water in the lumber 32 may be positively diffused to the surface, and the moisture may be removed in the dehumidifying step, wherein the drying time may be shortened and it is possible to prevent lumber 32 from being subjected to warping, internal cracking, breaking, shrinkage and bending.

(5) By depressurizing to −80 kPa through −97 kPa, all lumber 32 may be uniformly dried regardless of unevenness in moisture content at the initial stage of respective lumber 32. Insufficiently dried lumber may be prevented from being brought about, and time control may be easily carried out.

(6) By carrying out a dehumidifying step, lumber 32 may be dried until the target moisture content is gained in response to the type of lumber 32, wherein an uniformly dried state may be obtained.

(7) By giving vibrations to lumber 32 loaded on the carriage 28 by means of the vibration generating unit 29 in the depressurizing step, moisture in the core portion of the lumber 32 may be diffused to the outer surface, and at the same time, air of high humidity, which exists on the surface of the lumber 32, may be substituted by the ambient air. It is possible to uniformly dry the lumber 32 in a short time by synergic effects of heating, depressurizing and vibration.

(8) Since, as a post-step of the depressurizing step, the heating and humidifying step for humidifying to a humidity of 80% through 95% by means of the spraying unit 14 is carried out while heating the interior of the drying chamber 2 to a temperature set in a range from 40° C. through 60° C. by the heater 19, it is possible to recover the temperature and humidity of the drying chamber 2, which are lowered by the depressurizing step, and it is possible to prevent only the surface from being dried by supplying moisture to the surface of lumber 32. The inside of the lumber 32 and the surface thereof are uniformly dried with the drying balance secured, wherein it is possible to reduce the surface cracking.

(9) By repeatedly carrying out the depressurizing step and the heating and humidifying step, uniformly drying may be efficiently executed in a short time while securing balance in drying between the interior of lumber 32 and the surface thereof. Surface cracking may be effectively prevented from occurring, wherein the yield may be remarkably improved.

(10) By drying lumber 32 in the depressurization type drying machine 1 at a comparatively low temperature, moisture and effective constituents such as terpene, which are contained in the lumber 32 may be extracted without any waste, and may be effectively utilized as by-products.

(11) Since all the power sources are based on electricity, the cost saving properties are excellent by utilizing photovoltaic power generation and concluding a special agreement with a power company with respect to power consumption charges.

### Embodiment 2

FIG. 9 is a sectional front view of the major parts, showing a drying state of lumber in a depressurization type drying machine according to Embodiment 2, and FIG. 10 is a sectional view side taken along the line E-E of FIG. 9. Components that are identical to those of Embodiment 1 are given the same reference numerals, and description thereof is omitted.

In FIG. 9 and FIG. 10, reference numeral 1a denotes a depressurization drying machine according to Embodiment 2 of the invention. Reference numeral 48a denotes an air filter disposed at the tip end at the inner part side of the drying chamber 2 of the suction duct 8, 51b denotes an air filter disposed at the tip end at the inner part side of the drying chamber 2 of the depressurization pipe 11a, 52 denotes a blower that is disposed at the ceiling portion 2a of the drying chamber 2 and circulates air in the interior of the drying chamber 2, 53 denotes an inlet pipe, to which the air filter 53a is attached, for taking dry air existing in the interior of the drying chamber 2 into the blower 52, and 54 denotes an ambient air inflow pipe having the air filter 54a disposed at the tip end thereof for taking the ambient air outside the drying chamber 2 into the blower 52. Reference numeral 55a denotes an exhaust pipe for exhausting dry air taken in through the inlet pipe 53 or the ambient air taken in through the ambient air inflow pipe 54 into the interior of the drying chamber 2, 55b denotes an air feeding pipe for feeding dry air taken in through the inlet pipe 53 or the ambient air taken in through the ambient air inflow pipe 54 into the sidewall air path 58b described later, and 56a denotes a top plate for rectification, which is suspended from and fixed at the inner wall 3b of the ceiling portion 2a with predetermined clearance therefrom by fixing means 57a such as bolts and nuts and forms a ceiling air path 58a through which dry air sent through the air feeding duct 9 passes. Reference numeral 56b denotes a side plate for rectification, which extends from both sides of the top plate 56a for rectification, is supported by and fixed at the inner wall 3b of the sidewall portion 2b with predetermined clearance therefrom by fixing means 57b such as bolts and nuts, and forms a sidewall air path 58b through which dry air sent from the air feeding pipe 55b passes. Reference numerals 56c and 56d denote a plurality of air pores that are drilled in the surface of the top plate 56a for rectification and the side plate 56b for rectification, respectively, and jet air in the ceiling air path 58a and in the sidewall air path 58b toward the interior of the drying chamber 2. Reference numeral 65 denotes a floor plate for rectification, which is disposed at the inner wall 3b of the floor portion 2c of the drying chamber 2 with predetermined clearance and forms a floor air path 65a. Reference numerical 65b denotes a leg portion perpendicularly projected downward at both the left and right sides of the floor plate 65 for rectification, 65c denotes a plurality of air pores that are drilled in the surface of the floor plate 65 for rectification and jets air passing through the floor air path 65a toward the ceiling portion 2a of the drying chamber 2, and 66 denotes blower for floor, which is disposed between the floor plate 65 for rectification and the inner wall 3b and feeds air into the air path 65a.

By installing air filters 48a, 51b, 53a, and 54a are connected to the tip end at the suction sides of the suction duct 8, the depressurization pipe 11a, the inlet pipe 53, the ambient air inflow pipe 54, respectively, coarse particulates in the atmospheric air are prevented from entering the interior of the dehumidifier 7, the outdoor vacuum pump 11, and the blower 12. Also, in the present embodiment, although the suction ducts 8 and the air feeding ducts 9 are provided at three points, respectively, the number and arrangement thereof are not limited thereto. They may be appropriately selected in compliance with the capacity of the drying chamber 2 and the application thereof. In addition, the number of the dehumidifier 7 and the outdoor unit 10 may be appropriately selected based in the capacity of the drying chamber 2 and the application thereof.

By bringing the atmospheric air into the interior of the drying chamber 2 through the ambient air inflow pipe 54, it is possible to quickly return the depressurized state to the atmospheric pressure state, wherein it is possible to change to the operation for a subsequent process in a short time.

Further, since the heated drying chamber 2 may be cooled down by bringing the atmospheric air into the interior of the drying chamber 2 through the ambient air inflow pipe 54 after drying is completed, entrance to and exist from the drying chamber 2 is enabled in a short time, wherein it becomes possible to check the dried state of the materials to be dried, and to take the same out, and the work efficiency is excellent.

The top plate 56a for rectification, the side plates 56b for rectification and the floor plate 65 for rectification were made of metal such as stainless steel as well as rectification plate 16 in Embodiment 1, and air pores 56c, 56d and 65c in the surfaces thereof were formed as well as the air pores 16a of the rectification plate 16 in Embodiment 1.

The top plate 56a for rectification was disposed so that the rear end portion thereof is located at a lower position than the air feeding duct 9 at the rear sidewall 2e of the drying chamber 2. Therefore, dry air exhausted from the air feeding duct 9 may be securely guided to the ceiling air path 58a, and may be sent from the rear sidewall 2e side of the drying chamber 2 to the front sidewall 2d side by the blower 52.

A plurality of heaters 19 were concurrently installed in the widthwise direction and the lengthwise direction on the upper surface of the top plate 56a for rectification. Accordingly, dry air sent off from the dehumidifier 7 may be circulated by the blower 52 while heating the same, it is possible to uniformly heat the entirety of the drying chamber 2 in a short time, wherein the efficiency is excellent.

The leg portions 65b are suspended and installed at both sides of the floor plate 65 for rectification, respectively, and are detachably placed on the inner wall 3b of the floor portion 2c. Accordingly, the floor air path 65a is easily formed on the floor portion 2c, and at the same time, attachment and detachment thereof may be facilitated, wherein functionality and versatility are improved. Also, where the quantity of air from the dehumidifier 7 is sufficient and dry air is circulated only by the blower 52, there is no need to prepare the floor plate 65 for rectification and the blower 66 for floor. By removing the floor plate 65 for rectification and the blower 66 for floor, the number of components may be reduced, and the degree of freedom may be increased when the carriage 28 is let in and out of the drying chamber 2, wherein the work efficiency for bringing materials to be dried in and out may be improved.

A description is given below of a method for drying lumber using a depressurization type drying machine according to Embodiment 2, which is constructed as described above, with reference to the drawings.

In the first drying step, a heating step, in which the interior of the drying chamber 2 is heated at a temperature set in a range from 40° C. through 60° C. and at a humidity set in a range from 60% through 95%, and a depressurizing and vibrating step, in which in addition to the heating step, the interior of the drying chamber 2 is depressurized to −80 kPa through −95 kPa and lumber 32 loaded on the carriage 28 is vibrated at an amplitude of 0.5 mm through 1 mm by the vibration generating unit 29, are repeated. By carrying out the depressurizing and vibrating step, moisture in the core portion of the lumber 32 is diffused to the outer surface, and air having high humidity, which absorbs moisture on the surface of the lumber 32, is substituted by dry air, wherein the lumber 32 may be dried in a short time.

Where the moisture content is less than the moisture content set in a range from 25% through 30% in compliance with the type of the lumber 32, the second drying step is carried out. In the second drying step, the heating step in which the interior of the drying chamber 2 is heated at a temperature set in a range from 30° C. through 55° C. and a humidity set in a range from 35% through 75%, the depressurizing step in which, in addition to the heating step, the interior of the drying chamber 2 is depressurized to −80 kPa through −95 kPa, and the dehumidifying step in which the interior of the drying chamber 2 is dehumidified to a humidity of 40% through 60% with the heating step and the depressurizing step stopped, are repeated. Bound water of the lumber 32 is positively diffused onto the surface in the depressurizing step, and the moisture is removed by the dehumidifying step, whereby the drying time may be shortened.

Where the moisture content is less than the moisture content set in a range from 20% through 25% in compliance with the type of the lumber 32, the third drying step is carried out. In the third drying step, the interior of the drying chamber 2 is dehumidified to a humidity of 20% through 40%, and by carrying out the dehumidifying step the lumber 32 is dried until the target moisture content responsive to the type of the lumber 32 is obtained, wherein an uniformly dried state may be obtained.

As shown by the arrows in FIG. 9 and FIG. 10, dry air dehumidified by the dehumidifier 7 is sent from the rear sidewall 2e side of the drying chamber 2 to the front sidewall 2d side through the ceiling air path 58a, and is blown and circulated while absorbing moisture while moving from the front sidewall 2d side to the rear sidewall 2e side.

At this time, dry air is jetted from the air pores 56c of the ceiling plate 56a for rectification, the air pores 56d of the side plates 56b for rectification and the air pores 65c of the floor plate 65 for rectification toward the center of the drying chamber 2, respectively. The dry air passes through upside and downside clearance located vertically between lumber 32 and 32, which are lined up and supported, and clearance 32d formed at the left and right sides thereof, and uniformly covers the lumber 32 to enable uniformly drying.

With the depressurization type drying machine according to Embodiment 2 as described above, the following actions may be brought about in addition the actions of Embodiment 1.

(1) Since the dehumidifier 7 is disposed at the rear sidewall 2e side of the drying chamber 2, the top plate 56a for rectification and side plates 56b for rectification are disposed with predetermined clearance to the inner wall 3b on the ceiling portion 2a and on the sidewall portions 2b, and the ceiling air path 58a and the sidewall air path 58b are formed, dry air of a low temperature may be uniformly jetted through a plurality of air pores 56c and 56d drilled in the surfaces of the top plate 56a for rectification and the side plates 56b for rectification, so that the dry air may cover up the materials to be dried such as lumber 32, while blowing and circulating dry air to the ceiling air path 58a and the sidewall air path 58b by the blower 52 disposed on the ceiling portion 2a. The interior of the drying chamber 2 may be kept on uniformly drying conditions, and in particular, when drying lumber 32, it is possible to prevent the lumber 32 from being subjected to internal cracking, breaking, shrinkage and bending.

(2) Since the floor plate 65 for rectification is disposed at the floor portion 2c with predetermined clearance to the inner wall 3b, and the floor air path 65a is formed, dry air may be jetted toward downward of the materials to be dried such as lumber 32 through a plurality of air pores 65c drilled in the surface of the floor plate 65 for rectification while blowing and circulating dry air in the floor air path 65a by the blower 66 for floor, wherein it is possible to uniformly dry the entirety of the materials to be dried in all the directions, and in particular, when drying lumber 32, it is possible to prevent lumber 32 from being subjected to warping, internal cracking, breaking, shrinkage and bending.

(3) Since dry air may be blown from the front sidewall 2d side to the rear sidewall 2e side in the floor air path 65a by forming a floor air path 65a between the floor portion 2c and the floor plate 65 for rectification, air in the drying chamber 2 may be circulated, wherein the drying efficiency is excellent.

(4) Since the leg portions 65b are suspended from and installed at both the left and right sides of the floor plate 65 for rectification, respectively, and are detachably placed on the floor portion 2c, it is possible to easily form the floor air path 65a on the floor portion 2c, and at the same time, it may be easily detached therefrom, wherein the functionality and versatility are excellent.

The following actions may be brought about by the method for drying lumber using the depressurization type drying machine according to Embodiment 2.

(1) Since the method includes the first drying step in which the heating step and the depressurizing and vibrating step are repeated, the second drying step in which the heating step, the depressurizing step, and the dehumidifying step are repeated, and the third drying step in which the dehumidifying step is carried out, the drying conditions may be varied in compliance with the dried state of the lumber 32, wherein it is possible to efficiently carry out drying of the lumber 32.

(2) Since either of the heating steps in the first drying step through the third drying step is carried out at a relatively low temperature that is 60° C. or less, the lumber 32 is hardly damaged after drying is completed, and it is possible to prevent the lumber 32 from being subjected to warping, internal cracking, breaking, shrinkage, bending and discoloring, and gloss may remain on the surface, and scent may still remain after drying is completed, wherein the commercial value thereof may be enhanced.

(3) Since, in the first drying step, the depressurizing and vibrating step in which vibrations are given to lumber 32 while depressurizing the interior of the drying chamber 2 to −60 kPa through −95 kPa is carried out, moisture in the core portion of the lumber 32 is diffused to the outer surface, and at the same time, highly humid air that absorbed moisture on the surface of the lumber 32 may be substituted by dry air, wherein it is possible to uniformly dry the lumber 32 in a short time by a synergic effect of heating and depressurized vibration.

(4) Since: almost all free moisture in lumber 32 is removed, and a depressurizing step is carried out in the second drying step in which the moisture content is 25% through 30% at which advancement of drying becomes slow, bound water in the lumber 32 may be positively diffused to the surface, and the moisture is removed in the dehumidifying step, wherein the drying time may be shortened and it is possible to prevent lumber from being subjected to warping, internal cracking, breaking, shrinkage and bending.

(5) By depressurizing to −60 kPa through −95 kPa in the first drying step and the second drying step, all lumber may be uniformly dried regardless of unevenness in moisture content at the initial stage of respective lumber 32. Insufficiently dried lumber may be prevented from being brought about, and time control may be easily carried out resulting in productivity improvement.

(6) By intermittently carrying out a dehumidifying step in the second drying step, conditioning may be carried out, by which moisture in the inside of the lumber 32 is diffused and is made uniform. Surface-only drying may be prevented, in which only the surface is first dried. It is possible to prevent the lumber 32 from being subjected to warping, internal cracking, breaking, shrinkage and bending.

(7) Since the dehumidifying step is carried out in the third drying step, the lumber 32 may be dried until the target moisture content is obtained in response to the type of lumber 32, wherein uniformly dried state may be obtained.

### INDUSTRIAL APPLICABILITY

The present invention provides a depressurization type drying machine that is capable of repeatedly reducing the pressure, heating and humidifying during drying, uniformly drying a material to be dried, in a short time by applying vibrations to the material to be dried when reducing the pressure, and reducing consumption power without damaging the material to be dried, is excellent in reliability, productivity and energy-saving properties, brings about almost no flaws such as warping, internal cracking, breaking, shrinkage, and surface cracking, especially when drying lumber, is also capable of leaving gloss on the surface of lumber and scent without any discoloring, has high commercial value since the humidity in a building may be permanently controlled in response to the environment after being constructed, and is capable of extracting moisture contained in a material to be dried such as lumber without any waste and effectively utilizing the same as by-products, and the invention provides a method for drying lumber using a depressurization type drying machine that is excellent in energy-saving properties, is capable of drying lumber at high quality in a short time, and is excellent in productivity, wherein materials to be dried such as lumber may be utilized without any waste, and the resource-saving properties is excellent.

What is claimed is:

1. A depressurization type drying machine including: a drying chamber in which a ceiling portion, sidewall portions, and a floor portion are formed to be a dual-structure composed of an outer wall and an inner wall; a heat insulation layer formed between the outer wall and the inner wall; and a sealing type door disposed at the front sidewall portion of the drying chamber, and in which the interior of the drying chamber is depressurized, and a material to be dried in the drying chamber is dehumidified and dried at a low temperature; wherein at least the ceiling portion and sidewall portions are formed roughly like a circular arc swelled outwardly, and includes: reinforcement ribs disposed along the outer circumference of the inner wall parallel to and/or in orthogonal to the lengthwise direction of the drying chamber between the respective outer walls and inner walls of the ceiling portion, the sidewall portions and the floor portion; a dehumidifier disposed at the rear wall side of the drying chamber; an outdoor compressor interconnected with the dehumidifier; an outdoor vacuum pump interconnected with the drying chamber for depressurizing the interior thereof; a rectification plate disposed apart from the inner wall on the ceiling portion for forming a ceiling air path; a plurality of air pores drilled in the rectification plate; and a heater disposed on the ceiling portion of the drying chamber; wherein the rectification plate is spaced from the inner wall at both sides in the widthwise direction and is opened, the ceiling air path communicates with an air feeding duct of the dehumidifier at the rear wall of the drying chamber, and the air circulating unit disposed on the ceiling portion of the drying chamber includes a blower disposed at the rear wall side of the drying chamber; an air pipe connected to the blower and disposed in parallel to the lengthwise direction of the drying chamber at both sides of the ceiling portion; and a plurality of air jetting pores drilled in the air pipe.

2. The depressurization type drying machine according to claim 1, comprising: a temperature sensor for measuring the temperature in the drying chamber; a humidity sensor for measuring the humidity in the drying chamber; and a pressure sensor for measuring the depressurization degree in the drying chamber.

3. The depressurization type drying machine according to claims 1 or claim 2, including a spraying unit disposed at the front sidewall portion side of the drying chamber.

4. The depressurization type drying machine according to any one of claims 1 through 3, further including: a carriage disposed so as to be carried in and out of the interior of the drying chamber, on which the materials to be dried are loaded; and a vibration generating unit disposed on the carriage for giving vibrations to the materials to be dried.

5. A method for drying lumber using a depressurization type drying machine, comprising the steps of: heating the interior of the drying chamber of a depressurization type drying machine according to any one of claims 1 through 4 to a temperature set in a range from 40° C. through 60° C. by the heater; depressurizing the interior of the drying chamber to −80 kPa through −97 kPa by the outdoor vacuum pump; and dehumidifying the interior of the drying chamber at a temperature set in a range from 20° C. through 40° C. by the dehumidifier.

6. The method for drying lumber using a depressurization type drying machine according to claim 5, wherein lumber loaded on the carriage is given vibrations by means of the vibration generating unit according to claim 4 during the depressurization step.

7. A method for drying lumber using a depressurization type drying machine according to claim 5 or 6, wherein, as a post-step of the depressurizing step, a heating and humidifying step for humidifying to a humidity of 80% through 95% is carried out by means of the spraying unit according to claim 3 while heating the interior of the drying chamber to a temperature set in a range from 40° C. through 60° C. by the heater.

8. The method for drying lumber using a depressurization type drying machine according to claim 7, wherein the depressurizing step and the heating and humidifying step are repeatedly carried out.

9. (canceled)

10. (canceled)
